(19) United States
(12) Patent Application Publication
(10) Pub. No.: US 2019/0037034 A1
(43) Pub. Date: Jan. 31, 2019

(54) MOBILE TERMINAL AND METHOD FOR CONTROLLING THE SAME

(71) Applicant: LG ELECTRONICS INC., Seoul (KR)

(72) Inventors: Hyunok LEE, Seoul (KR); Changseok CHO, Seoul (KR); Cheol KANG, Seoul (KR); Cheegoog KIM, Seoul (KR); Hongjoo KIM, Seoul (KR); Woonghee PARK, Seoul (KR); Mansoo SIN, Seoul (KR); Ramchan WOO, Seoul (KR); Hyungjoo CHEON, Seoul (KR); Kyungsoo HWANG, Seoul (KR); Sanghoon HWANG, Seoul (KR)

(73) Assignee: LG ELECTRONICS INC., Seoul (KR)

(21) Appl. No.: 15/885,123

(22) Filed: Jan. 31, 2018

(30) Foreign Application Priority Data
Jul. 28, 2017 (KR) 10-2017-0096483

(51) Int. Cl. H04L 29/08; H04W 4/02; G06F 3/041

(52) U.S. Cl. CPC H04L 67/18; H04W 4/02; G07C 2009/00396; H04M 2250/10; H04M 2250/52; G06F 3/0412

(57) ABSTRACT

A mobile terminal including a communication unit including a GPS module and configured to receive a request signal for controlling a vehicle; and a controller configured to transmit a control signal for controlling the vehicle through the communication unit in response to the request signal when a location of the vehicle acquired through the GPS module indicates the mobile terminal is within a first distance from the vehicle, and not transmit the control signal for controlling the vehicle through the communication unit in response to the request signal when the location of the vehicle acquired through the GPS module indicates the mobile terminal is within a second distance from the vehicle greater than the first distance.

### CROSS-REFERENCE TO RELATED APPLICATION

Pursuant to 35 U.S.C. § 119(a), this application claims the benefit of earlier filing date and right of priority to Korean Application No. 10-2017-0096483, filed on Jul. 28, 2017, the contents of which is incorporated by reference herein in its entirety.

### BACKGROUND OF THE INVENTION

### 1. Field of the Invention

The present disclosure relates to a mobile terminal capable of communicating with a vehicle and a control method thereof.

### 2. Description of the Related Art

Terminals can be divided into mobile/portable terminals and stationary terminals. Mobile terminals may also be classified as handheld terminals or vehicle mounted terminals.

The functions of mobile terminals are diversified. For example, the functions can include data and voice communication, photographing and video shooting through a camera, voice recording, music file playback through a speaker system, and displaying an image or video on a display unit. Some terminals further include an electronic game play function or perform a multimedia player function. In particular, in recent years, mobile terminals can receive multicast signals that provide visual content such as broadcast, video or television programs.

As it becomes multifunctional, for example, such a terminal is allowed to capture still images or moving images, play music or video files, play games, receive broadcast and the like, so as to be implemented as an integrated multimedia player. In order to support and enhance the functions of the terminal, the improvement of structural or software elements of the terminal can be taken into consideration.

In recent years, a passive keyless entry (PKE)/remote keyless entry (RKE) for opening and closing a door is provided in a vehicle. Here, as an example, the PKE/RKE performs a function of allowing a driver to open or close the door of the vehicle using a lock button or an unlock button. In the related art, a user must separately carry a vehicle key (e.g., a physical vehicle key, a key fob, a smart key) for controlling the vehicle, and lock/unlock the door of the vehicle through the vehicle key.

However, in recent years, technologies for controlling a vehicle in a more convenient manner have been actively developed. In addition, in recent years, as technologies for locking or unlocking a door of a vehicle through a PKE/RKE function is applied to a lot of vehicles, there arises a problem about a relay attack that steals the vehicle using a signal amplifier.

### SUMMARY OF THE INVENTION

An object of the present disclosure is to provide a mobile terminal capable of controlling a vehicle in an optimized manner and a control method thereof.

Another object of the present disclosure is to provide a mobile terminal capable of preventing a relay attack of a vehicle by using a mobile terminal capable of controlling the vehicle and a control method thereof.

Still another object of the present disclosure is to provide a mobile terminal capable of preventing a relay attack of a vehicle by using a mobile terminal capable of controlling the vehicle and a control method thereof.

A mobile terminal according to an embodiment of the present disclosure includes a communication unit configured to receive a request signal associated with a vehicle, and a controller configured to transmit a control signal associated with the vehicle through the communication unit in response to the request signal, wherein the communication unit includes a GPS module, and the controller determines whether or not to transmit a control signal associated with the vehicle based on the location of the mobile terminal acquired through the GPS module.

A method of controlling a mobile terminal according to an embodiment of the present disclosure includes receiving a request signal associated with a vehicle; and determining whether or not to transmit a control signal associated with the vehicle based on a location of the mobile terminal acquired through the GPS module.

The effects of a mobile terminal according to the present disclosure and a control method thereof will be described as follows. The present disclosure can acquire a location of a mobile terminal through a GSP module provided in the mobile terminal, and determine whether or not to transmit a control signal responding to a request signal associated with the vehicle based on the acquired location of the mobile terminal, thereby providing a novel control method capable of preventing a relay attack of the vehicle.

Furthermore, the present disclosure can provide a mobile terminal capable of determining whether or not to transmit a control signal responding to a request signal associated with a vehicle according to a change in location of the mobile terminal, thereby preventing a relay attack of the vehicle in an optimized manner.

In addition, the present disclosure can determine whether or not to transmit a control signal responding to a request signal associated with a vehicle based on information acquired from a mobile terminal (e.g., a movement of the mobile terminal, a difference between atmospheric pressures detected by a parked vehicle and the mobile terminal, and a user schedule using the mobile terminal), thereby providing a novel control method capable of effectively preventing a relay attack caused by a weak point of a smart key.

Further scope of applicability of the present disclosure will become apparent from the detailed description given hereinafter. However, it should be understood that the detailed description and specific examples such as preferred embodiments of the invention are given by way of illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a mobile terminal associated with the present disclosure;

FIG. 2 is a conceptual view illustrating a PKE/RKE function of a vehicle key module of the present disclosure;

FIG. 3 is a conceptual view illustrating a relay attack of a vehicle;

FIG. 4 is a block diagram illustrating explaining a representative control method of the present disclosure;

FIGS. 5, 6A, 6B and 7 are conceptual views illustrating the control method illustrated in FIG. 4; and

FIGS. 8-23 are conceptual views illustrating a method for preventing a relay attack of a vehicle using a mobile terminal according to an embodiment of the present disclosure.

### DETAILED DESCRIPTION OF THE INVENTION

Hereinafter, preferred embodiments of the present disclosure will be described in detail with reference to the accompanying drawings, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. The accompanying drawings are used to help easily understand the technical idea of the present disclosure and it should be understood that the idea of the present disclosure is not limited by the accompanying drawings.

Although the terms first, second, etc. can be used herein to describe various elements, these elements should not be limited by these terms. These terms are generally only used to distinguish one element from another.

When an element is referred to as being “connected with” another element, the element can be directly connected with the other element or intervening elements may also be present. In contrast, when an element is referred to as being “directly connected with” another element, there are no intervening elements present.

A singular representation can include a plural representation as far as it represents a definitely different meaning from the context. Terms “include” or “has” used herein should be understood that they are intended to indicate an existence of several components or several steps, disclosed in the specification, and it may also be understood that part of the components or steps may not be included or additional components or steps may further be included.

Mobile terminals described herein can include cellular phones, smart phones, laptop computers, digital broadcasting terminals, personal digital assistants (PDAs), portable multimedia players (PMPs), navigators, slate PCs, tablet PCs, ultrabooks, wearable devices (for example, smart watches, smart glasses, head mounted displays (HMDs)), and the like.

However, it can be easily understood by those skilled in the art that the configuration according to the exemplary embodiments of this specification can also be applied to stationary terminals such as digital TV, desktop computers and the like, excluding a case of being applicable only to the mobile terminals.

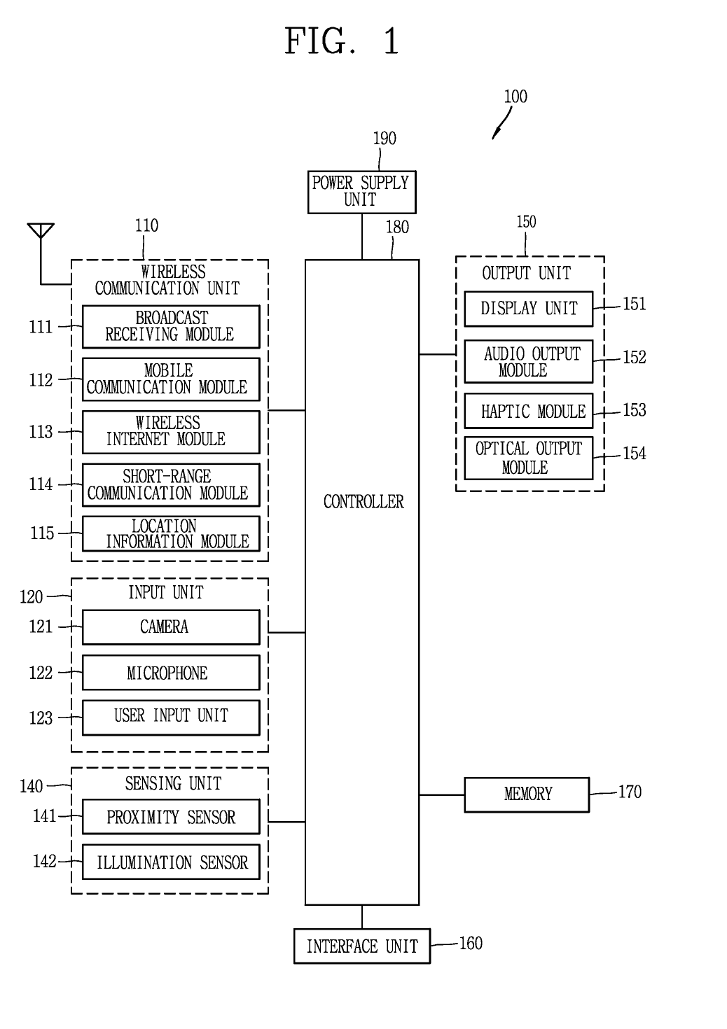

FIG. 1 is a block diagram illustrating a mobile terminal associated with the present disclosure. The mobile terminal 100 can include components, such as a wireless communication unit 110, an input unit 120, a sensing unit 140, an output unit 150, an interface unit 160, a memory 170, a controller 180, a power supply unit 190 and the like. FIG. 1A illustrates the mobile terminal having various components, but it can be understood that implementing all of the illustrated components is not a requirement. Greater or fewer components may alternatively be implemented.

In more detail, the wireless communication unit 110 of those components may typically include one or more modules which permit wireless communications between the mobile terminal 100 and a wireless communication system, between the mobile terminal 100 and another mobile terminal 100, or between the mobile terminal 100 and an external server. In addition, the wireless communication unit 110 can include one or more modules that connect the mobile terminal 100 to one or more networks.

The wireless communication unit 110 can include at least one of a broadcast receiving module 111, a mobile communication module 112, a wireless Internet module 113, a short-range communication module 114, a location information module 115 and the like. The input unit 120 can include a camera 121 for inputting an image signal, a microphone 122 or an audio input module for inputting an audio signal, or a user input unit 123 (for example, a touch key, a push key (or a mechanical key), etc.) for allowing a user to input information. Audio data or image data collected by the input unit 120 can be analyzed and processed by a user's control command.

The sensing unit 140 can include at least one sensor which senses at least one of internal information of the mobile terminal, a surrounding environment of the mobile terminal and user information. For example, the sensing unit 140 can include a proximity sensor 141, an illumination sensor 142, a touch sensor, an acceleration sensor, a magnetic sensor, (G-sensor), gyroscope sensor, motion sensor, RGB sensor, infrared sensor (IR sensor: An infrared sensor, a finger scan sensor, an ultrasonic sensor, an optical sensor (for example, see camera 121), a microphone (see 122), a battery gauge), An environmental sensor (for example, a barometer, a hygrometer, a thermometer, a radiation sensor, a heat sensor, a gas sensor, etc.), a chemical sensor (e.g., an electronic nose, a healthcare sensor, One can be included. The mobile terminal 100 can be configured to utilize information obtained from sensing unit 140, and in particular, information obtained from one or more sensors of the sensing unit 140, and combinations thereof.

The output unit 150 can be configured to output an audio signal, a video signal or a tactile signal. The output unit 150 can include a display unit 151, an audio output unit 152, a haptic module 153, an optical output unit 154 and the like. The display unit 151 may have an inter-layered structure or an integrated structure with a touch sensor in order to facilitate a touch screen. The touch screen may provide an output interface between the mobile terminal 100 and a user, as well as functioning as the user input unit 123 which provides an input interface between the mobile terminal 100 and the user.

The interface unit 160 serves as an interface with various types of external devices that can be coupled to the mobile terminal 100. The interface unit 160, for example, can include wired or wireless headset ports, external power supply ports, wired or wireless data ports, memory card ports, ports for connecting a device having an identification module, audio input/output (I/O) ports, video I/O ports, earphone ports, or the like. The mobile terminal 100 can execute an appropriate control associated with a connected external device, in response to the external device being connected to the interface unit 160.

In addition, the memory 170 stores data that support various functions of the mobile terminal 100. The memory 170 is typically implemented to store data to support various functions or features of the mobile terminal 100. For instance, the memory 170 can be configured to store application programs executed in the mobile terminal 100, data or instructions for operations of the mobile terminal 100, and the like. At least some of those application programs can be downloaded from an external server via wireless communication. Some others of those application programs can be installed within the mobile terminal 100 at the time of being shipped for basic functions of the mobile terminal 100 (for example, receiving a call, placing a call, receiving a message, sending a message, etc.). Further, the application programs can be stored in the memory 170, installed in the mobile terminal 100, and executed by the controller 180 to perform an operation (or a function) of the mobile terminal 100.

The controller 180 can typically control an overall operation of the mobile terminal 100 in addition to the operations associated with the application programs. The controller 180 can provide or process information or functions appropriate for a user by processing signals, data, information and the like, which are input or output by the aforementioned components, or activating the application programs stored in the memory 170.

Furthermore, the controller 180 can control at least part of the components illustrated in FIG. 1, in order to drive the application programs stored in the memory 170. In addition, the controller 180 can drive the application programs by combining at least two of the components included in the mobile terminal 100 for operation.

The power supply unit 190 can receive external power or internal power and supply appropriate power required for operating respective elements and components included in the mobile terminal 100 under the control of the controller 180. The power supply unit 190 can include a battery, and the battery can be an embedded battery or a replaceable battery.

At least part of those elements and components can be combined to implement operation and control of the mobile terminal or a control method of the mobile terminal according to various exemplary embodiments described herein. Furthermore, the operation and control or the control method of the mobile terminal can be implemented in the mobile terminal in such a manner of activating at least one application program stored in the memory 170.

Hereinafter, each aforementioned component will be described in more detail with reference to FIG. 1, prior to explaining various exemplary embodiments implemented by the mobile terminal 100 having the configuration. First, the wireless communication unit 110 will be described. The broadcast receiving module 111 of the wireless communication unit 110 can receive a broadcast signal and/or broadcast associated information from an external broadcast managing entity via a broadcast channel. The broadcast channel can include a satellite channel and/or a terrestrial channel. At least two broadcast receiving modules 111 can be provided in the portable electronic device 100 to simultaneously receive at least two broadcast channels or switch the broadcast channels.

The mobile communication module 112 can transmit/receive wireless signals to/from at least one of network entities, for example, a base station, an external terminal, a server, and the like, on a mobile communication network, which is constructed according to technical standards or transmission methods for mobile communications (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), etc.)

Here, the wireless signals can include an audio call signal, a video (telephony) call signal, or various formats of data according to transmission/reception of text/multimedia messages. The wireless Internet module 113 refers to a module for supporting wireless Internet access, and can be built-in or externally installed on the mobile terminal 100. The wireless Internet module 113 can transmit and/or receive wireless signals via communication networks according to wireless Internet technologies.

Examples of such wireless Internet access can include Wireless LAN (WLAN), Wireless-Fidelity (Wi-Fi), Wireless Fidelity Direct (Wi-Fi Direct), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), LTE (Long Term Evolution), LTE-A (Long Term Evolution-Advanced), and the like. The wireless Internet module 113 can transmit/receive data according to at least one wireless Internet technology within a range including even Internet technologies which are not aforementioned.

From the perspective that the wireless Internet accesses according to Wibro, HSDPA, GSM, CDMA, WCDMA, LET and the like are executed via a mobile communication network, the wireless Internet module 113 which performs the wireless Internet access via the mobile communication network can be understood as a type of the mobile communication module 112.

The short-range communication module 114 denotes a module for short-range communications. Suitable technologies for implementing the short-range communications can include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, and the like. The short-range communication module 114 may support wireless communications between the mobile terminal 100 and a wireless communication system, between the mobile terminal 100 and another mobile terminal 100, or between the mobile terminal and a network where another mobile terminal 100 (or an external server) is located, via wireless personal area networks. The short-range communication module 114 denotes a module for short-range communications.

Here, the another mobile terminal 100 can be a wearable device, for example, a smart watch, smart glasses or a head mounted display (HMD), which can exchange data with the mobile terminal 100 (or to like data with the mobile terminal 100). The short-range communication module 114 may sense (recognize) a wearable device, which can communicate with the mobile terminal), near the mobile terminal 100. In addition, when the sensed wearable device is a device which is authenticated to communicate with the mobile terminal 100 according to the present disclosure, the controller 180 can transmit at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. For example, when the mobile terminal uses the GPS module, a position of the mobile terminal can be acquired using a signal sent from a GPS satellite. As another example, when the mobile terminal uses the Wi-Fi module, a position of the mobile terminal can be acquired based on information associated with a wireless access point (AP) which transmits or receives a wireless signal to or from the Wi-Fi module. According to the need, the location information module 115 may perform any function of the other modules of the wireless communication unit 110 to obtain data on the location of the mobile terminal. As a module used to acquire the location (or current location) of the mobile terminal, the location information module 115 may not be necessarily limited to a module for directly calculating or acquiring the location of the mobile terminal.

The input unit 120 can be configured to provide an audio or video signal (or information) input to the mobile terminal or information input by a user to the mobile terminal. For the input of the audio information, the mobile terminal 100 can include one or a plurality of cameras 121. The camera 121 processes an image frame, such as still picture or video, obtained by an image sensor in a video phone call or image capturing mode. The processed image frames can be displayed on the display unit 151. Further, the plurality of cameras 121 disposed in the mobile terminal 100 can be arranged in a matrix configuration. By use of the cameras 121 having the matrix configuration, a plurality of image information having various angles or focal points can be input into the mobile terminal 100. As another example, the cameras 121 can be located in a stereoscopic arrangement to acquire left and right images for implementing a stereoscopic image.

The microphone 122 may process an external audio signal into electric audio data. The processed audio data can be utilized in various manners according to a function being executed in the mobile terminal 100 (or an application program being executed). Further, the microphone 122 can include assorted noise removing algorithms to remove noise generated in the course of receiving the external audio signal.

The user input unit 123 can receive information input by a user. When information is input through the user input unit 123, the controller 180 can control an operation of the mobile terminal 100 to correspond to the input information. The user input unit 123 can include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input can be a virtual key or a soft key, which is displayed on a touch screen through software processing, or a touch key which is located on the mobile terminal at a location that is other than the touch screen. Further, the virtual key or the visual key can be displayed on the touch screen in various shapes, for example, graphic, text, icon, video, or a combination thereof.

Further, the sensing unit 140 may sense at least one of internal information of the mobile terminal, surrounding environment information of the mobile terminal and user information, and generate a sensing signal corresponding to it. The controller 180 can control an operation of the mobile terminal 100 or execute data processing, a function or an operation associated with an application program installed in the mobile terminal based on the sensing signal. Hereinafter, description will be given in more detail of representative sensors of various sensors which can be included in the sensing unit 140.

First, a proximity sensor 141 refers to a sensor to sense presence or absence of an object approaching to a surface to be sensed, or an object disposed near a surface to be sensed, by using an electromagnetic field or infrared rays without a mechanical contact. The proximity sensor 141 can be arranged at an inner region of the mobile terminal covered by the touch screen, or near the touch screen.

The proximity sensor 141, for example, can include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 may sense proximity of a pointer to the touch screen by changes of an electromagnetic field, which is responsive to an approach of an object with conductivity. In this instance, the touch screen (touch sensor) may also be categorized as a proximity sensor.

Further, for the sake of brief explanation, a state that the pointer is positioned to be proximate onto the touch screen without contact will be referred to as “proximity touch,” whereas a state that the pointer substantially comes in contact with the touch screen will be referred to as “contact touch.” For the position corresponding to the proximity touch of the pointer on the touch screen, such position will correspond to a position where the pointer faces perpendicular to the touch screen upon the proximity touch of the pointer. The proximity sensor 141 may sense proximity touch, and proximity touch patterns (e.g., distance, direction, speed, time, position, moving state, etc.). Further, the controller 180 can process data (or information) corresponding to the proximity touches and the proximity touch patterns sensed by the proximity sensor 141, and output visual information corresponding to the process data on the touch screen. In addition, the controller 180 can control the mobile terminal 100 to execute different operations or process different data (or information) according to whether a touch with respect to the same point on the touch screen is either a proximity touch or a contact touch.

A touch sensor may sense a touch (or touch input) applied onto the touch screen (or the display unit 151) using at least one of various types of touch methods, such as a resistive type, a capacitive type, an infrared type, a magnetic field type, and the like.

As one example, the touch sensor can be configured to convert changes of pressure applied to a specific part of the display unit 151 or a capacitance occurring from a specific part of the display unit 151, into electric input signals. Also, the touch sensor can be configured to sense not only a touched position and a touched area, but also touch pressure. Here, the touch object body can be a finger, a touch pen or stylus pen, a pointer, or the like as an object through which a touch is applied to the touch sensor.

When a touch input is sensed by a touch sensor, corresponding signals can be transmitted to a touch controller. The touch controller may process the received signals, and then transmit corresponding data to the controller 180. Accordingly, the controller 180 can sense which region of the display unit 151 has been touched. Here, the touch controller can be a component separate from the controller 180 or the controller 180 itself.

Further, the controller 180 can execute a different control or the same control according to a type of an object which touches the touch screen (or a touch key provided in addition to the touch screen). Whether to execute the different control or the same control according to the object which gives a touch input can be decided based on a current operating state of the mobile terminal 100 or a currently executed application program.

In addition, the touch sensor and the proximity sensor can be executed individually or in combination, to sense various types of touches, such as a short (or tap) touch, a long touch, a multi-touch, a drag touch, a flick touch, a pinch-in touch, a pinch-out touch, a swype touch, a hovering touch, and the like.

An ultrasonic sensor can be configured to recognize position information relating to a sensing object by using ultrasonic waves. The controller 180 can calculate a position of a wave generation source based on information sensed by an illumination sensor and a plurality of ultrasonic sensors. Since light is much faster than ultrasonic waves, a time for which the light reaches the optical sensor can be much shorter than a time for which the ultrasonic wave reaches the ultrasonic sensor. The position of the wave generation source can be calculated using this fact. For instance, the position of the wave generation source can be calculated using the time difference from the time that the ultrasonic wave reaches the sensor based on the light as a reference signal.

The camera 121 constructing the input unit 120 can be a type of camera sensor. The camera sensor can include at least one of a photo sensor (or image sensor) and a laser sensor.

Implementing the camera 121 with a laser sensor may allow detection of a touch of a physical object with respect to a 3D stereoscopic image. The camera 121 and the laser sensor can be combined to detect a touch of the sensing object with respect to a 3D stereoscopic image. More specifically, the photo sensor is integrated with photo diodes and transistors in the rows and columns thereof, and a content placed on the photo sensor can be scanned by using an electrical signal that is changed according to the amount of light applied to the photo diode. Namely, the photo sensor may calculate the coordinates of the sensing object according to variation of light to thus obtain position information of the sensing object.

The display unit 151 may output information processed in the mobile terminal 100. For example, the display unit 151 may display execution screen information of an application program driven in the mobile terminal 100 or user interface (UI) and graphic user interface (GUI) information in response to the execution screen information.

Furthermore, the display unit 151 may also be implemented as a stereoscopic display unit for displaying stereoscopic images. The stereoscopic display unit may employ a stereoscopic display scheme such as stereoscopic scheme (a glass scheme), an auto-stereoscopic scheme (glassless scheme), a projection scheme (holographic scheme), or the like.

The audio output module 152 is generally configured to output audio data. Such audio data can be obtained from any of a number of different sources, such that the audio data can be received from the wireless communication unit 110 or may have been stored in the memory 170. Also, the audio output unit 152 may also provide audible output signals associated with a particular function (e.g., a call signal reception sound, a message reception sound, etc.) performed by the mobile terminal 100. The audio output module 152 can include a receiver, a speaker, a buzzer or the like.

A haptic module 153 may generate various tactile effects that the user may feel. A typical example of the tactile effect generated by the haptic module 153 can be vibration. Strength, pattern and the like of the vibration generated by the haptic module 153 can be controllable by a user selection or setting of the controller. For example, the haptic module 153 may output different vibrations in a combining manner or a sequential manner.

Besides vibration, the haptic module 153 may generate various other tactile effects, including an effect by stimulation such as a pin arrangement vertically moving with respect to a contact skin, a spray force or suction force of air through a jet orifice or a suction opening, a touch on the skin, a contact of an electrode, electrostatic force, etc., an effect by reproducing the sense of cold and warmth using an element that can absorb or generate heat, and the like.

The haptic module 153 can be configured to transmit tactile effects through a user's direct contact, or a user's muscular sense using a finger or a hand. Two or more haptic modules 153 can be provided according to the particular configuration of the mobile terminal 100.

An optical output module 154 may output a signal for indicating an event generation using light of a light source. Examples of events generated in the mobile terminal 100 can include a message reception, a call signal reception, a missed call, an alarm, a schedule notice, an email reception, an information reception through an application, and the like.

A signal output by the optical output module 154 can be implemented so the mobile terminal emits monochromatic light or light with a plurality of colors. The signal output can be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 can include wired or wireless headset ports, external power supply ports, wired or wireless data ports, memory card ports, ports for connecting a device having an identification module, audio input/output (I/O) ports, video I/O ports, earphone ports, or the like.

The identification module can be a chip that stores various information for authenticating authority of using the mobile terminal 100 and can include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

Furthermore, when the mobile terminal 100 is connected with an external cradle, the interface unit 160 may serve as a passage to allow power from the cradle to be supplied to the mobile terminal 100 therethrough or may serve as a passage to allow various command signals input by the user from the cradle to be transferred to the mobile terminal therethrough. Such various command signals or power input from the cradle may operate as signals for recognizing that the mobile terminal 100 has accurately been mounted to the cradle.

The memory 170 can store programs to support operations of the controller 180 and store input/output data (for example, phonebook, messages, still images, videos, etc.). The memory 170 may store data associated with various patterns of vibrations and audio which are output in response to touch inputs on the touch screen.

The memory 170 can include at least one type of storage medium including a Flash memory, a hard disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 can be operated in relation to a web storage device that performs the storage function of the memory 170 over the Internet.

As aforementioned, the controller 180 can typically control the general operations of the mobile terminal 100. For example, the controller 180 can set or release a lock state for restricting a user from inputting a control command with respect to applications when a state of the mobile terminal meets a preset condition.

Furthermore, the controller 180 can also perform controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein on the mobile terminal 100.

The power supply unit 190 can receive external power or internal power and supply appropriate power required for operating respective elements and components included in the electronic device 100 under the control of the controller 180. The power supply unit 190 can include a battery, which is typically rechargeable or be detachably coupled to the terminal body for charging.

Furthermore, the power supply unit 190 can include a connection port. The connection port can be configured as one example of the interface unit 160 to which an external (re)charger for supplying power to recharge the battery is electrically connected.

As another example, the power supply unit 190 can be configured to recharge the battery in a wireless manner without use of the connection port. Here, the power supply unit 190 can receive power, transferred from an external wireless power transmitter, using at least one of an inductive coupling method which is based on magnetic induction or a magnetic resonance coupling method which is based on electromagnetic resonance. Various embodiments described herein can be implemented in a computer-readable or its similar medium using, for example, software, hardware, or any combination thereof.

The location information module 115 of the mobile terminal is configured to acquire a position of the mobile terminal. Such location information module 115 can include a Global Position System (GPS) module and a Wireless Fidelity (Wi-Fi) module. According to the need, the location information module 115 may perform any function of the other modules of the wireless communication unit 110 to obtain data on the location of the mobile terminal.

The GPS module 115 may measure an accurate time and distance from three or more satellites, and accurately calculate a current location of the mobile terminal according to trigonometry based on the measured time and distances. At present, there is widely used a method of calculating position and time information using three satellites and correcting an error of the calculated position and time information using another satellite. Furthermore, the GPS module can acquire speed information in real time to calculate a current position. Sometimes, accuracy of a measured position can be compromised when the mobile terminal is located in a blind spot of satellite signals, such as being located in an indoor space. In order to minimize the effect of such blind spots, an alternative or supplemental location technique, such as Wi-Fi Positioning System (WPS), can be utilized.

The WiFi positioning system (WPS) refers to a location determination technology based on a wireless local area network (WLAN) using WiFi as a technology for tracking the location of the mobile terminal 100 using a WiFi module provided in the mobile terminal 100 and a wireless access point for transmitting and receiving wireless signals to and from the WiFi module.

The Wi-Fi positioning system can include a Wi-Fi location determination server, a mobile terminal 100, a wireless access point (AP) connected to the mobile terminal, and a database stored with any wireless AP information. The mobile terminal 100 connected to the wireless AP can transmit a location information request message to the Wi-Fi location determination server.

The Wi-Fi location determination server extracts the information of the wireless AP connected to the mobile terminal 100, based on the location information request message (or signal) of the mobile terminal 100. The information of the wireless AP can be transmitted to the Wi-Fi location determination server through the mobile terminal 100, or can be transmitted to the Wi-Fi location determination server from the wireless AP.

The information of the wireless AP extracted based on the location information request message of the mobile terminal 100 can be at least one of MAC address, Service Set IDentification (SSID), Received Signal Strength Indicator (RSSI), Reference Signal Received Power (RSRP), Reference Signal Received Quality (RSRQ), channel information, privacy, network type, signal strength and noise strength.

The Wi-Fi location determination server can receive the information of the wireless AP connected to the mobile terminal 100 as described above, and may extract wireless AP information corresponding to the wireless AP connected to the mobile terminal from the pre-established database. The information of any wireless APs stored in the database can be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database. Information included therein is compared with the received wireless AP information to extract (analyze) the location information of the mobile terminal 100.

A method for extracting (analyzing) location information of the mobile terminal 100 can include a Cell-ID method, a fingerprint method, a trigonometry method, a landmark method, etc. The Cell-ID method is used to determine a position of a wireless AP having the largest signal strength, among peripheral wireless AP information collected by a mobile terminal, as a position of the mobile terminal. The Cell-ID method is advantageous in that an implementation is simple, additional costs are not required, and location information can be rapidly acquired. However, the Cell-ID method is disadvantageous in that precision of positioning is lowered when an installation density of a wireless AP is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless AP, signal strength can be converted into distance information, or Time of Arrival (ToA) taken for wireless signals to be transmitted can be used.

The landmark method is used to measure a position of a mobile terminal using a known landmark transmitter. In addition to these position location methods, various algorithms can be used to extract (analyze) location information of a mobile terminal. Such extracted location information of the mobile terminal 100 is transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 can be variously changed according to a wireless communication environment where the mobile terminal 100 is positioned.

As aforementioned with reference to FIG. 1, a short-range communication technique, such as Bluetooth™, Radio Frequency Identification (RFID), Infrared Data Association (IrDA), Ultra Wideband (UWB), ZigBee and Near Field Communication (NFC), can be applicable to the mobile terminal according to the present disclosure.

An NFC module provided at the mobile terminal supports short-range wireless communication, a non-contactable type between mobile terminals, within about 10 cm. The NFC module may operate in one of a card mode, a reader mode and a P2P mode. The mobile terminal 100 can further include a security module for storing card information, in order to operate the NFC module in a card mode. The mobile terminal 100 can further include a security module for storing card information, in order to operate the NFC module in a card mode. The security module can be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange can be performed between the NFC module and the security module.

When the NFC module operates in a card mode, the mobile terminal can transmit card information on a general IC card to outside. Specifically, if a mobile terminal having card information on a payment card (e. g, a credit card or a bus card) approaches a card reader, a short-range mobile payment can be executed. As another example, if a mobile terminal which stores card information on an entrance card approaches an entrance card reader, an entrance approval procedure may start. A card such as a credit card, a traffic card, or an entrance card can be included in the security module in the form of applet, and the security module may store card information on the card mounted therein. Card information for a payment card can include any of a card number, a remaining amount and usage history, and the like. Card information of an entrance card can be at least one of a user's name, a user's number (e.g., undergraduate number or staff number) and an entrance history.

When the NFC module operates in a reader mode, the mobile terminal may read data from an external tag. The data received from the external tag by the mobile terminal can be coded into the NFC Data Exchange Format defined by the NFC Forum. The NFC Forum defines four record types. More specifically, the NFC Forum defines four RTDs (Record Type Definitions) such as Smart Poster, Text, URI (Uniform Resource Identifier) and General Control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call.

When the NFC module operates in a peer-to-peer (P2P) mode, the mobile terminal may execute P2P communication with another mobile terminal. In this instance, Logical Link Control Protocol (LLCP) can be applied to the P2P communication. For P2P communication, connection can be generated between the mobile terminal and another mobile terminal. This connection can be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. can be switched. The P2P mode can be effectively utilized in switching data of a small capacity, because an available distance for NFC communication is relatively short.

Hereinafter, embodiments associated with a control method which can be implemented in the mobile terminal having the foregoing configuration will be described with reference to the attached drawings. It should be understood by those skilled in the art that the present disclosure can be embodied in other specific forms without departing from the concept and essential characteristics thereof.

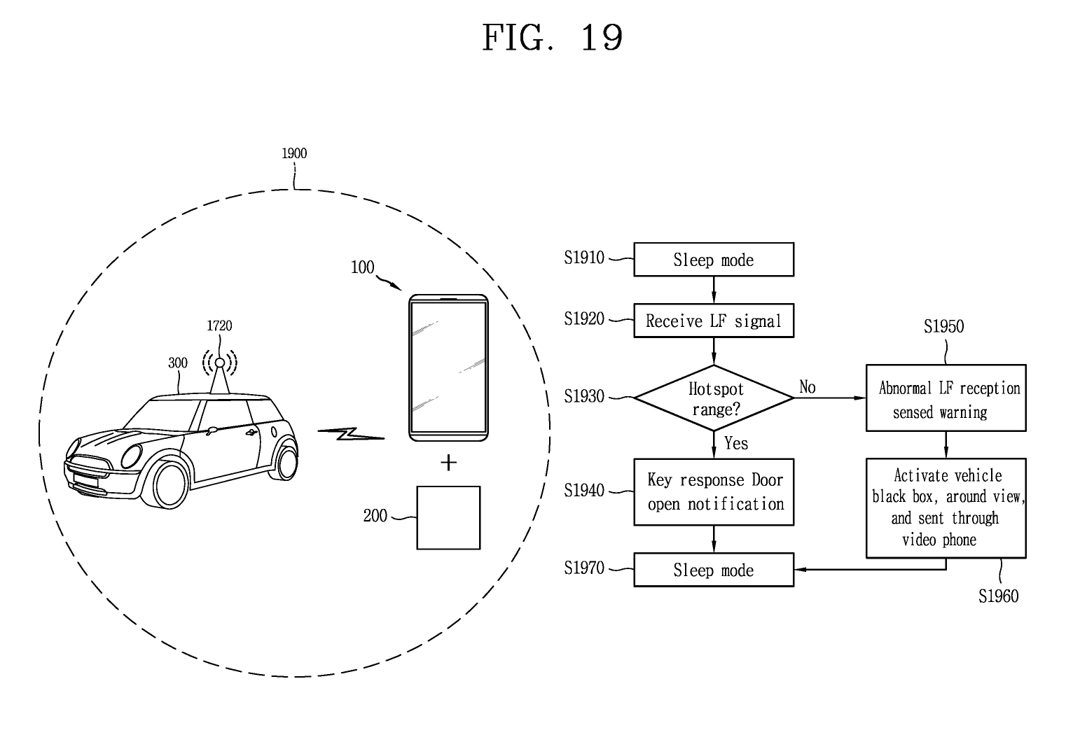

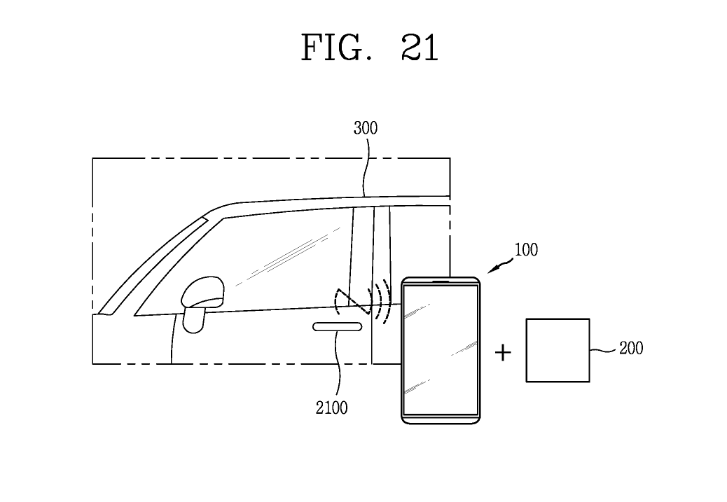

In addition, the mobile terminal 100 of the present disclosure can include a vehicle key module 200 (e.g., see FIGS. 19 and 21) capable of controlling the vehicle. The vehicle key module 200 can be formed to be separated from the mobile terminal 100, and formed in a detachable manner from the mobile terminal 100.

In addition, the vehicle key module 200 can be included in the mobile terminal 100 as an element or can be included in the controller 180. When the vehicle key module 200 is included in the controller 180, the vehicle key module 200 can be provided in the form of a single chip in the controller 180 or can be a software component included in the controller 180.

The vehicle key module 200 may perform all the functions/operations/controls of a vehicle key, a smart key, which generally control the vehicle. It should be noted that all the functions/operations/controls for controlling the vehicle by the vehicle key module 200 described herein may also be performed by the controller 180. Furthermore, all the functions/operations/controls performed by the controller 180 described herein can be performed by the vehicle key module 200.

The present disclosure can control a vehicle 300 in various manners using the mobile terminal 100 including the vehicle key module 200. Hereinafter, the vehicle key module 200 of the mobile terminal according to an embodiment of the present disclosure capable of controlling the vehicle will be described in more detail.

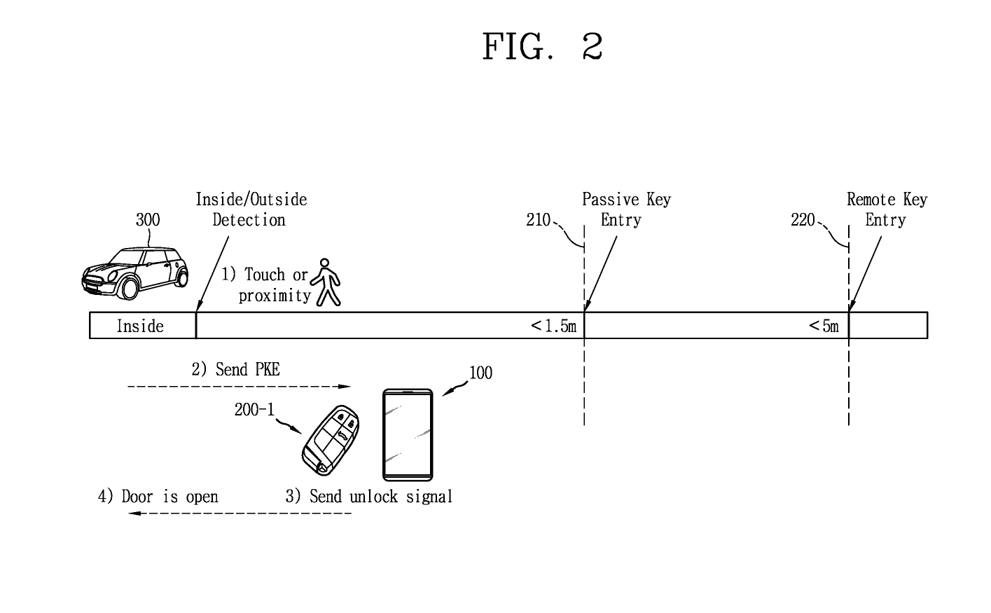

In particular, FIG. 2 is a conceptual view illustrating a PKE/RKE function of a vehicle key module of the present disclosure. First, referring to FIG. 2, the mobile terminal 100 or the vehicle key module 200 of the present disclosure can include a PKE-RKE IC (Passive Keyless Entry Integrated Circuit).

Here, the vehicle key module 200 can be included in the mobile terminal 100. Thus, a function/operation/control of the vehicle key module 200 can be performed by the manipulation of the mobile terminal. The present disclosure is not limited to this, and the vehicle key module 200 can be included in a vehicle key 200-1 as illustrated in FIG. 2. In other words, the vehicle key module 200 described below can include a function/operation/control method of the vehicle key 200-1.

The PKE-RKE IC can be formed to perform a PKE function and/or a RKE function. Here, the PKE function can include a function of allowing a user to lock/unlock a car door, open the trunk (or glove box, etc.) of the vehicle, or perform an operation (of starting the engine of the vehicle) by simply holding a car key (vehicle key module) without manipulating it.

Furthermore, the PKE function can include an operation of locking or unlocking the door of the vehicle when a lock button/unlock button provided on the vehicle (for example, a handle of the car door) is pressed and the vehicle key module exists within a predetermined distance of the vehicle. In addition, the PKE function can include an operation of opening the trunk when a button provided on a part of the trunk is pressed and the vehicle key module exists within a predetermined distance from the trunk of the vehicle.

In addition, the PKE function can include an operation of starting a vehicle (or starting (driving) the engine of the vehicle) only when the vehicle key module exists in the vehicle. Such an operation can be understood as an immobilizer function.

Further, a LF (Low Frequency) antenna and/or a UHF (Ultra High Frequency) antenna can be used for the PKE function. Here, the UHF antenna can be generally referred to as an RF (Radio Frequency) antenna. The LF antenna and/or the UHF antenna can be provided in the mobile terminal. Also, the vehicle key module 200 can perform a PKE/RKE function using the LF antenna and/or the UHF antenna provided in the mobile terminal.

An example of the PKE function will be described as follows. The LF antenna can be provided at each portion of the vehicle (e.g., at a front side of the vehicle, at the door of the vehicle, at a rear side of the vehicle (e.g., trunk), or inside the vehicle). A low-frequency signal transmitted from the LF antenna can be set or designed to be transmitted to a predetermined distance (for example, about 1.5 m).

When the operation of the user applied to the vehicle (for example, pressing of a button provided on a handle of the car door or access to a specific part of the vehicle) is performed, the vehicle can transmit a low-frequency signal through the LF antenna provided on a portion at which the user's operation is sensed (or at least one LF antenna provided in the vehicle). Here, the transmitted low-frequency signal can be referred to as a request signal or a PKE signal associated with a vehicle.

When the low-frequency signal is received through the LF antenna (or the PKE antenna) provided in the PKE-RKE IC, the vehicle key module (or the mobile terminal) can transmit a high-frequency signal to the vehicle through the UHF antenna (RKE antenna) in response to the received low-frequency signal. Here, the high-frequency signal transmitted to the vehicle by the vehicle key module (or mobile terminal) in response to the low-frequency signal can be referred to as a control signal associated with the vehicle or a response signal or RKE signal associated with the vehicle.

When the low-frequency signal is received through the LF antenna (or the PKE antenna) provided in the PKE-RKE IC, the vehicle key module (or mobile terminal) can transmit a response signal to the vehicle through the LF antenna (or PKE antenna). The vehicle can lock/unlock a door, open a trunk, or start an engine based on the high-frequency signal or the low-frequency signal received from the vehicle key module (or mobile terminal).

For example, when the received signal has an authorized frequency, has a specific frequency previously associated with the vehicle, or is a signal including authentication information, the vehicle can perform an operation corresponding to the user's operation (e.g., lock/unlock a door with a lock button/unlock button pressed, open a trunk or start an engine, etc.).

The RKE function refers to a function of remotely controlling the vehicle using a car key (vehicle key module). For example, when a button (e.g., a door lock/unlock button, a horn output button, a trunk open button, a start button, etc.) provided in the vehicle key module (or mobile terminal) is selected, the high-frequency signal associated with the selected button can be transmitted through the UHF antenna (or RF antenna) provided in the PKE-RKE IC.

Further, the vehicle can perform a function corresponding to the button (e.g., door lock/unlock, horn output, trunk open, engine start, etc.) based on the high-frequency signal received from the vehicle key (vehicle key module). The high-frequency signal transmitted through the UHF antenna can be transmitted to a farther distance than the low-frequency signal transmitted from the LF antenna. For example, the high-frequency signal can be transmitted to several tens to several hundred meters.

Referring to FIG. 2, a region where a low-frequency signal (a request signal associated with the vehicle) transmitted through the LF antenna is transmitted and received between the vehicle 300 and the vehicle key module 200 (or mobile terminal) is referred to as a first region 210. The first region 210 in which the request signal associated with the vehicle is transmitted and received (or transmitted from the vehicle to the mobile terminal (vehicle key module)) has a radius of 1.5 m with respect to the vehicle 300.

Furthermore, a region where a high-frequency signal (a control signal associated with the vehicle) transmitted through the UHF antenna is transmitted and received between the vehicle 300 and the vehicle key module 200 (or mobile terminal) is referred to as a second region 220. The second region 220 in which the control signal associated with the vehicle is transmitted and received (or transmitted from the mobile terminal (vehicle key module) to the vehicle) is a region where the high-frequency signal is transmitted and received between the vehicle and the mobile terminal, and thus has a radius larger than that of the first region 210. As an example, it is assumed that the second region 220 has a radius of 5 m, as illustrated in FIG. 2.

According to the present disclosure, the PKE-RKE IC formed to perform a PKE function and/or a RKE function can be provided in the mobile terminal and/or vehicle key module (or vehicle key). In the PKE-RKE IC, a controller for controlling the PKE/RKE function can be formed as a single chip, a first chip performing the PKE function, or as two chips such as a second chip performing the RKE function, or as three chips including a separate MCU in addition to the first chip and the second chip.

Furthermore, the PKE-RKE IC can include a tuner for tuning a frequency (high frequency) transmitted from the UHF antenna. Further, the low frequency and high frequency used for communication with the vehicle can be different for each company/vehicle type/country. For example, the low-frequency signal used for the PKE function can have a frequency (or a frequency band) of 125 kHz, 134 kHz, 22 kHz, and the like, and the high-frequency signal used for the RKE function can have a frequency (or a frequency band) of 315 MHz, 434 MHz, 903 MHz, and the like.

The mobile terminal and/or the vehicle key module of the present disclosure can be provided with a plurality of LF antennas (PKE antennas) and a plurality of UHF antennas (RKE antennas) to enable the output of all frequencies used for each company/vehicle type/country. In addition, the PKE-RKE IC provided in the mobile terminal and/or the vehicle key module can set a low frequency and a high frequency so as to communicate with the user's vehicle according to the setting of the user, and when the vehicle is changed, the low frequency and high frequency capable of communicating with the changed vehicle can be reset through a predetermined authorization process.

Through such a configuration, the present disclosure can provide a mobile terminal and a vehicle key module capable of controlling all types of vehicles, that is, capable of controlling the vehicle in a general manner, using one mobile terminal (or vehicle key module). The PKE function and the RKE function can include various operations associated with the vehicle in addition to the operations described above, and is not limited to the operations described above. In addition, the PKE/RKE function may also be referred to as a PKE/RKE technology and a RKE technology or PKE/RKE.

In summary, when a preset operation associated with the vehicle is performed in the vehicle 300 while the vehicle key module 200 (vehicle key 200-1) or the first mobile terminal 100 exists within the first region 210 capable of receiving a request signal associated with the vehicle from the vehicle 300, the vehicle 300 can transmit a request signal associated with the vehicle through the PKE function. At this time, a request signal associated with the vehicle can be transmitted from the vehicle 300 in the form of a low-frequency signal through the LF antenna.

Here, the preset operation associated with the vehicle can include an operation of pressing a lock/unlock button provided at a door of the vehicle, an operation of putting a hand into a handle of the vehicle, an operation of moving the vehicle key module (or mobile terminal) toward the vehicle, an operation of moving the vehicle key module (or the mobile terminal) away from the vehicle 300, an operation of pressing a start button of the vehicle, an operation of pressing a button provided at a trunk of the vehicle, an operation of causing a preset movement of a user (e.g., moving the user's foot into a bottom of the trunk, moving the user's foot in one direction at the bottom of the trunk, or repeatedly moving the user's foot in one direction and the other direction at the bottom of the trunk) or the like (refer to 1) in touch or in proximity in FIG. 2).

The request signal associated with the vehicle can be a signal corresponding to a preset operation associated with the vehicle (refer to 2) send PKE in FIG. 2). For example, when an operation of pressing the lock/unlock button, an operation of putting a hand into the handle of the vehicle or an operation of moving the vehicle key module (or mobile terminal) toward the vehicle 300 is sensed while the door of the vehicle is closed, the vehicle 300 can send a signal requesting to unlock the vehicle door. In this instance, the request signal associated with the vehicle can be a signal requesting to unlock the vehicle door.

In another example, when an operation of pressing the lock/unlock button or an operation of moving the vehicle key module (or mobile terminal) away from the vehicle 300 is sensed while the door of the vehicle is open, the vehicle 300 can send a signal requesting to lock the vehicle door. In this instance, the request signal associated with the vehicle can be a signal requesting to lock the vehicle door.

In still another example, when a button provided on the trunk of the vehicle is pressed or a preset movement of the user is sensed at the bottom of the trunk of the vehicle, the vehicle 300 can send a signal requesting to open the trunk. In this instance, the request signal associated with the vehicle can be a signal requesting to open the vehicle door.

In yet still another example, when a start button of the vehicle is pressed, the vehicle 300 can send a signal requesting to operate the engine of the vehicle (turn on the vehicle). In this instance, the request signal associated with the vehicle can be a signal requesting to operate the engine of the vehicle.

When the mobile terminal 100 (or vehicle key module 200) exists within the first region 210 capable of receiving a request signal associated with the vehicle, the mobile terminal 100 (or vehicle key module 200) can receive a request signal associated with the vehicle that has been sent from the vehicle 300.

Specifically, the mobile terminal 100 (or vehicle key module 200) can receive a request signal associated with the vehicle only when a preset operation is performed in the vehicle while it is within the first region 210. This is because the request signal associated with the vehicle that has been sent from the vehicle in response to the preset operation generated from the vehicle is a low-frequency signal received through the LF antenna as a PKE function, and the low-frequency signal can be sent only up to a region within a radius of about 1.5 m (first region 210).

If the mobile terminal 100 (or vehicle key module 200) is present in a region out of the first region 210, it may be unable to receive a request signal associated with the vehicle sent from the vehicle 300. Then, when the request signal associated with the vehicle is received while the mobile terminal 100 exists within the first region 210 with respect to the vehicle 300, the mobile terminal 100 can transmit a control signal associated with the vehicle in response to the request signal associated with the vehicle, (refer to 3) send an unlock signal in FIG. 2).

The control signal associated with the vehicle can be a response signal corresponding to a request signal associated with the vehicle, and denote a signal for controlling (instructing) the vehicle to perform an operation corresponding to the request signal. For example, when the request signal associated with the vehicle is a signal requesting to unlock the vehicle door, the control signal associated with the vehicle can be a signal controlling to unlock the vehicle door (or a signal associated with a function of unlocking the vehicle door).

In another example, when the request signal associated with the vehicle is a signal requesting to unlock the vehicle door, the control signal associated with the vehicle can be a signal controlling to unlock the vehicle door (or a signal associated with a function of unlocking the vehicle door).

In still another example, when the request signal associated with the vehicle is a signal requesting to open the vehicle trunk, the control signal associated with the vehicle can be a signal controlling to open the vehicle trunk (or a signal associated with a function of opening the vehicle trunk). In yet still another example, when the request signal associated with the vehicle is a signal requesting to operate the engine of the vehicle (or a signal requesting to start the vehicle), the control signal associated with the vehicle can be a signal controlling to operate the engine of the vehicle (or a signal associated with a function of turning on the startup of the vehicle). In addition, the control signal associated with the vehicle can refer to a signal controlling to perform an operation (function/control) of the vehicle included in the request signal associated with the vehicle.

The mobile terminal 100 (or vehicle key module 200) can transmit a control signal associated with the vehicle through the communication unit 110, in response to a request signal associated with the vehicle. In this instance, when a control signal associated with the vehicle is transmitted from the mobile terminal 100 to the vehicle 300, the vehicle 300 can perform an operation (function/control) of the vehicle corresponding to the control signal associated with the vehicle (refer to 4) open a door in FIG. 2).

The control signal associated with the vehicle can be a high-frequency signal transmitted from the UHF antenna through the RKE function or a low-frequency signal transmitted from the LF antenna through the PKE function, as described above. Through such a configuration, the mobile terminal (vehicle key module) and the vehicle can more easily provide a PKE/RKE function capable of controlling the vehicle by directly manipulating the vehicle without manipulating the mobile terminal (or vehicle key module).

It should be noted that all the functions/operations/controls for controlling the vehicle by the vehicle key module 200 described herein can also be performed by the controller 180. Furthermore, all the functions/operations/controls performed by the controller 180 described herein can be performed by the vehicle key module 200.

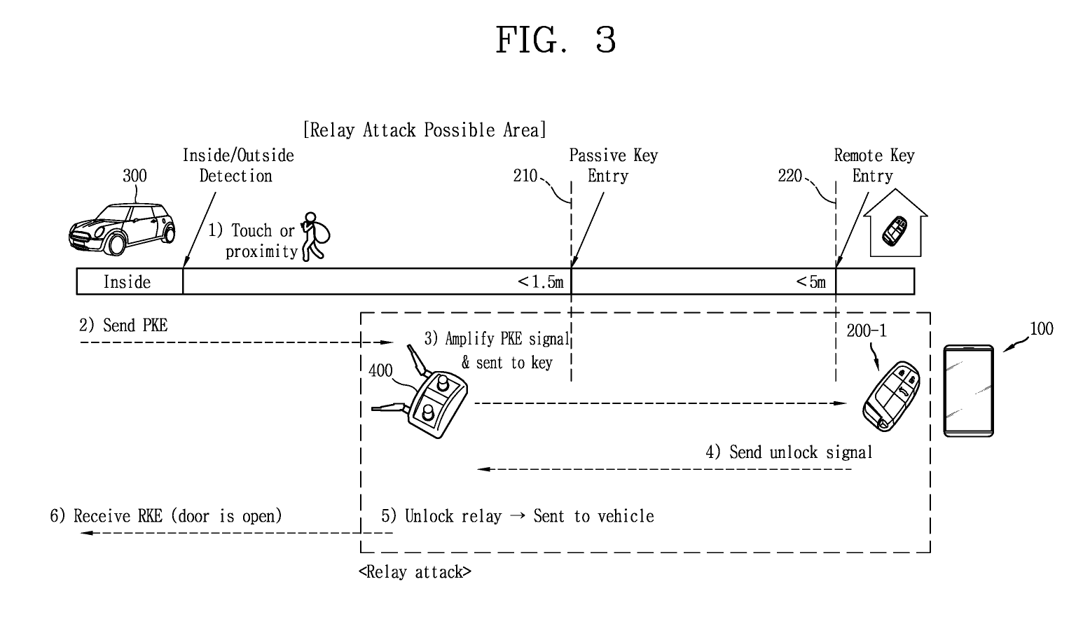

Further, in recent years, there has been a problem about a relay attack that steals a vehicle using the weak points of the foregoing PKE/RKE function. Hereinafter, a relay attack for stealing a vehicle will be described in more detail. Referring to FIG. 3, a relay attack can denote a method of transmitting a request signal associated with a vehicle sent from the vehicle 300 to the mobile terminal 100 (or vehicle key module 200, vehicle key 200-1) using an amplifier 400 even when the mobile terminal 100 (or vehicle key module 200, vehicle key 200-1) exists in a region out of the first region 210 capable of receiving a request signal associated with the vehicle from the vehicle, and receiving a control signal associated with the vehicle sent from the mobile terminal 100 (or vehicle key module 200, vehicle key 200-1) from the amplifier 400 to allow the amplifier 400 to transmit it to the vehicle 300, thereby operating the vehicle to steal it.

Specifically, as illustrated in FIG. 3, when a preset operation associated with the vehicle is performed in the vehicle while the mobile terminal (or vehicle key module 200, vehicle key 200-1) is out of the first region 210 with respect to the vehicle 300, a request signal associated with the vehicle sent from the vehicle 300 is normally not transmitted to the mobile terminal. This is because the mobile terminal is located outside the first region 210.

However, when the amplifier 400 is present, the mobile terminal 100 can receive a request signal associated with the vehicle sent from the vehicle 300 even when the mobile terminal 100 is located outside the first region 210. Specifically, when a preset operation associated with the vehicle is performed in the vehicle while the amplifier 400 is present within the first region 210 from the vehicle 300 (refer to 1) in touch or in proximity in FIG. 3), the vehicle 300 transmits a request signal associated with the vehicle corresponding to the preset operation (refer to 2) send a PKE signal in FIG. 3), and the amplifier 400 receives the request signal associated with the vehicle.

Then, the amplifier 400 amplifies the received request signal associated with the vehicle and transmits the amplified request signal to the mobile terminal (or vehicle key module) located out of the first region 210 (refer to 3) amplify the PKE signal and sent it to the key in FIG. 3). In response to receiving the request signal associated with the vehicle, the mobile terminal (or vehicle key module) sends out a control signal associated with the vehicle corresponding to the received request signal (refer to 4) unlock signal in FIG. 3).

The control signal associated with the vehicle sent from the mobile terminal (or the vehicle key module) is transmitted (transferred) to the amplifier 400. Then, the amplifier 400 transmits (transfers) the transmitted control signal associated with the vehicle to the vehicle 300 (refer to 5) send an unlock relay->car in FIG. 3). Then, when the control signal associated with the vehicle is received from the amplifier 400, the vehicle 300 performs an operation of the vehicle corresponding to the received control signal (refer to 6) receive RKE (open the door) in FIG. 3).

Further, a control signal associated with a vehicle sent from a mobile terminal (or vehicle key module) can be transmitted directly to the vehicle 300 without passing through the amplifier 400, since it uses a high-frequency signal. Accordingly, even when the mobile terminal (or vehicle key module, vehicle key) is present in the first region incapable of receiving a request signal (low-frequency signal, PKE signal) associated with the vehicle from the vehicle 300, a request signal (a low-frequency signal, a PKE signal) associated with the vehicle to be sent from the vehicle can be transferred to the mobile terminal (or vehicle key module, vehicle key) to generate a control signal associated with the vehicle from the mobile terminal (or vehicle key module, vehicle key).

A control signal associated with a vehicle generated (sent) from a mobile terminal (or vehicle key module, vehicle key) can be transferred to the vehicle via an amplifier or transferred directly to the vehicle to allow the vehicle to operate in response to the control signal, thereby implementing an operation of the vehicle that is undesired by the vehicle owner. Through such a process, in recent years, a case of a relay attack in which the vehicle 300 is stolen using the amplifier 400 has been increased in the light of the weak points of the PKE/RKE function.

However, the present disclosure can provide a mobile terminal capable of preventing a relay attack using the mobile terminal and a control method thereof. Specifically, the mobile terminal of the present disclosure can perform various functions using various components as well as controlling the vehicle, as illustrated in FIG. 1. The mobile terminal 100 can prevent a relay attack on the vehicle using various components provided in the mobile terminal. Also, the mobile terminal 100 can prevent a relay attack on the vehicle based on information acquired from the mobile terminal.

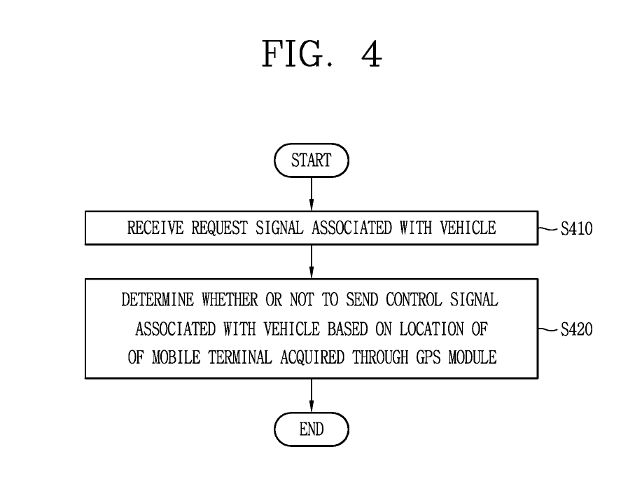

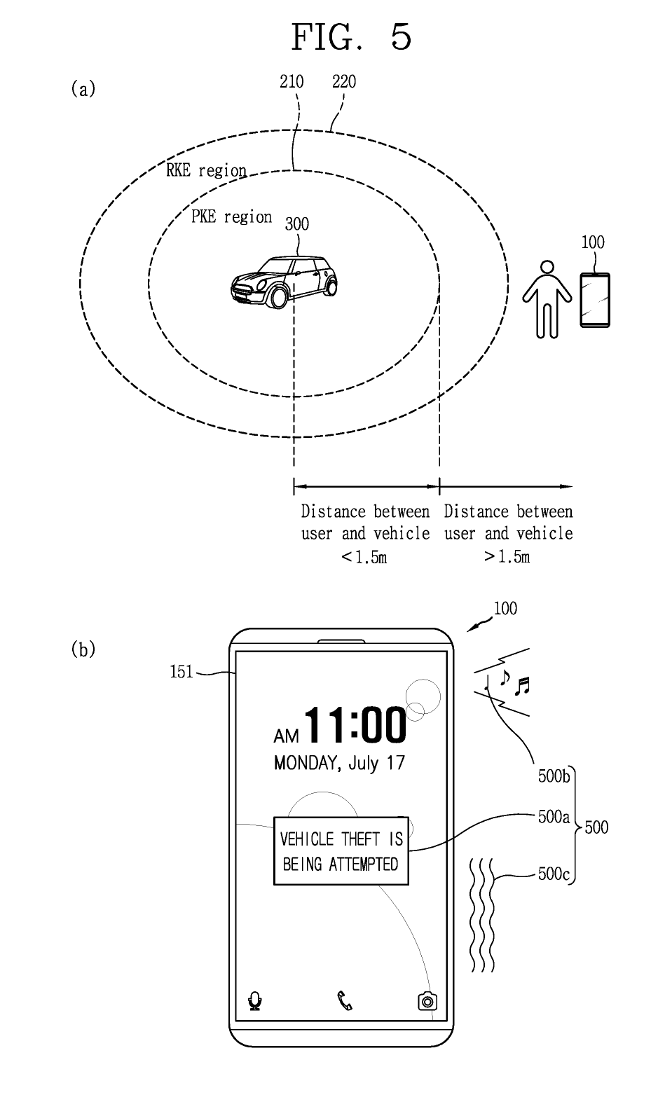

Hereinafter, a method of preventing a relay attack on a vehicle using a mobile terminal will be described in more detail with reference to the accompanying drawings. In particular, FIG. 4 is a flowchart illustrating a representative control method of the present disclosure, and FIGS. 5, 6A, 6B, and 7 are conceptual views illustrating the control method illustrated in FIG. 4.

First, the mobile terminal 100 associated with the present disclosure can include the vehicle key module 200, as described above, and can be formed to control the vehicle 300. The mobile terminal 100 can include the communication unit 110 and the controller 180. The communication unit 110 can be the wireless communication unit 110 described above.

Referring to FIG. 4, the communication unit 110 can receive a request signal associated with a vehicle (S410). The request signal associated with the vehicle can be transmitted from the vehicle 300 or sent from the vehicle 300 and received at the amplifier 400, and then received from the amplifier 400.

The vehicle 300 can send a request signal associated with the vehicle corresponding to a preset operation based on the occurrence of a preset operation associated with the vehicle in the vehicle. Here, the request signal associated with the vehicle can be sent as a low-frequency signal through the PKE function.

The request signal associated with the vehicle received through the communication unit 110 can be transmitted to the communication unit 110 of the mobile terminal 100 from the vehicle 300 as the mobile terminal 100 is present within the first region 210 capable of receiving the request signal associated with the vehicle from the vehicle 300. Furthermore, the request signal associated with the vehicle received through the communication unit 110 can be transmitted to the communication unit 110 of the mobile terminal 100 through the amplifier 400 that is present within the first region 210 even when the mobile terminal 100 is located at a position outside the first area 210 with respect to the vehicle 300.

Then, the controller 180 can transmit (send) a control signal associated with the vehicle through the communication unit 110 in response to the request signal. The mobile terminal 100 according to an embodiment of the present disclosure can determine whether or not to transmit (send) a control signal corresponding to the request signal upon receiving the request signal, based on the location of the mobile terminal.

Specifically, the communication unit 110 can include a GPS module 115, and the controller 180 can acquire (receive, detect, sense, extract, judge, determine) the location of the mobile terminal 100 through the GPS module 115. The controller 180 can determine whether or not to transmit a control signal associated with the vehicle based on the location of the mobile terminal acquired through the GPS module 115 (S420). Specifically, when a request signal associated with the vehicle is received through the communication unit 110, the controller 180 can determine whether or not to send a control signal associated with the vehicle corresponding to the request signal based on the location of the mobile terminal 100 and the vehicle 300.

For example, when the request signal associated with the vehicle is received through the communication unit 110, the controller 180 can acquire the location of the mobile terminal 100 using the GSP module 115. In addition, the controller 180 can acquire the location of the vehicle 300 in various ways.

For example, when a specific operation is performed in the vehicle (for example, any one or a combination of at least two of turning off a startup of the vehicle, locking a door of the vehicle or sensing that the driver gets off the vehicle, the controller 180) can determine (judge) the location information of the vehicle using the location of the mobile terminal acquired through the GPS module 115 when the location information of the vehicle is received from the vehicle 300 or the specific operation is performed in the vehicle.

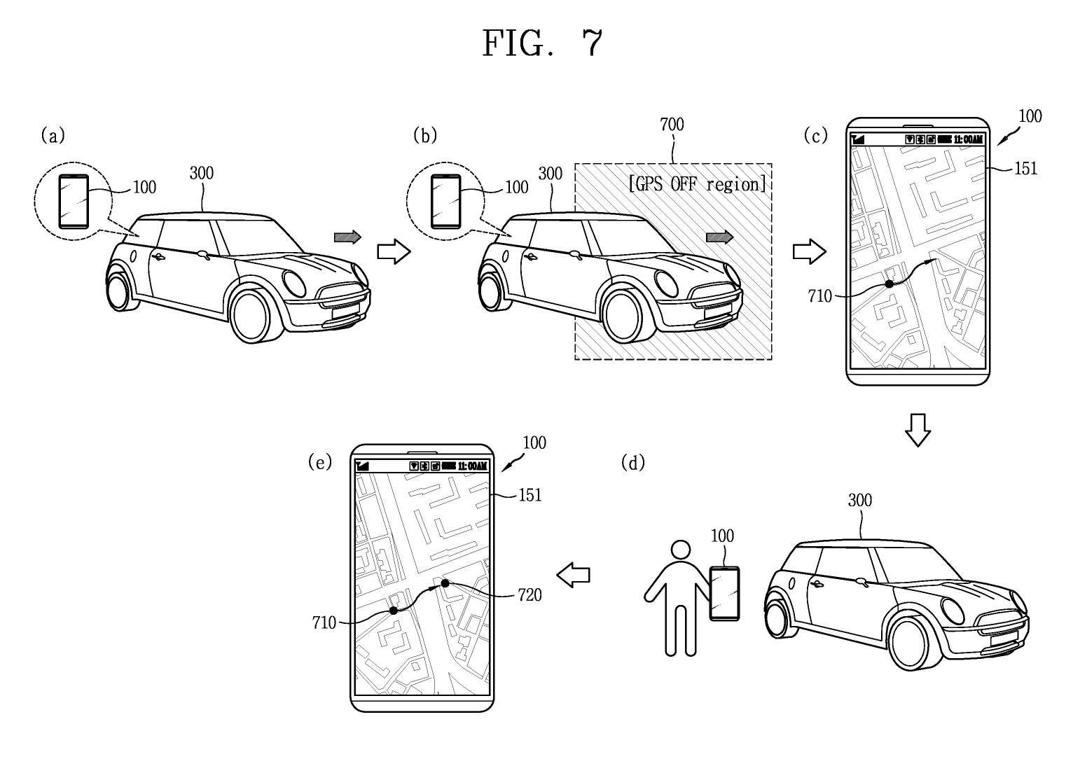

In addition, the controller 180 of the mobile terminal 100 can acquire (determine, judge) the location information of the vehicle 300 in various manners, which will be described later in detail with reference to FIG. 7. When a request signal associated with the vehicle is received and the location (or location information) of the vehicle 300 and the location (or location information) of the mobile terminal 100 are acquired, the controller 180 can determine (judge) how far the mobile terminal 100 is away from the vehicle 300.

For example, the controller 180 can determine whether or not the terminal 100 is present within the first region 210 capable of receiving a request signal from the vehicle 300 based on the location of the vehicle and the location of the mobile terminal. As described above, it is assumed herein that the first region 210 is a region capable of transmitting a low-frequency signal (a request signal associated with the vehicle) by a PKE function in the vehicle, for example, a radius of 1.5 m, as described above.

The controller 180 can determine whether or not to transmit a control signal associated with a vehicle based on whether or not the mobile terminal 100 is present within the first region 210 capable of receiving a request signal associated with the vehicle from the vehicle 300 with respect to the vehicle 300. For example, as illustrated in FIG. 5A, when the mobile terminal 100 is present outside the first region 210, the controller 180 can not transmit the control signal associated with the vehicle.

As illustrated in FIG. 5A, when the mobile terminal 100 is present outside the first region 210 (or when the mobile terminal 100 is away from the vehicle than a distance capable of receiving a request signal associated with the vehicle sent from the vehicle 300), the controller 180 can determine that a relay attack is being attempted by the amplifier 400 when a response signal associated with the vehicle is received.

Accordingly, when a request signal associated with the vehicle is received through the communication unit 110 and the mobile terminal 100 is out of the first region 210 with respect to the vehicle 300 (or when a distance between the vehicle 300 and the mobile terminal 100 is greater than a distance capable of receiving a low-frequency signal (PKE signal) sent from the vehicle 300), the controller 180 can not respond to the request signal (or not send (or transmit) a control signal associated with the vehicle corresponding to the request signal even if the request signal is received).

In other words, according to the present disclosure, when the mobile terminal 100 receives a request signal associated with the vehicle while being farther away than a predetermined distance (a distance capable of receiving a low-frequency signal (a PKE signal, a request signal associated with the vehicle) sent from the vehicle, for example, 1.5 m), the controller 180 can determine that it is a relay attack using the amplifier 400, and not send a control signal associated with the vehicle in response to the request signal.

Furthermore, when a request signal associated with the vehicle is received and the mobile terminal is present outside the first region 210 capable of receiving the request signal associated with the vehicle sent from the vehicle with respect to the vehicle 300, the controller 180 can display notification information 500 indicating that there is a theft attempt (relay attack attempt) of the vehicle 300.

Here, the notification information 500 can include screen information 500a including at least one of an image, a graphic object and a text displayed through the display unit 151 of the mobile terminal 100, a notification sound 500b output through the audio output unit 152, and a vibration 500c output through the haptic module 153. Through this configuration, the present disclosure can provide a novel mobile terminal capable of preventing a relay attack using a GPS module provided in the mobile terminal 100 (or based on the location information of the mobile terminal acquired through the GPS module), and a control method thereof.

Therefore, the present disclosure can provide a novel user interface capable of accurately determining whether a relay attack has occurred using the GPS module, and informing the owner of the vehicle of notification information indicating that there is a relay attack attempt through the mobile terminal.

Further, when the mobile terminal 100 is present within the first region 210 capable of receiving a request signal associated with the vehicle from the vehicle with respect to the vehicle 300, the mobile terminal 100 according to an embodiment of the present disclosure can determine whether or not to transmit a control signal associated with the vehicle in response to the request signal according to whether or not the mobile terminal 100 satisfies a preset condition.

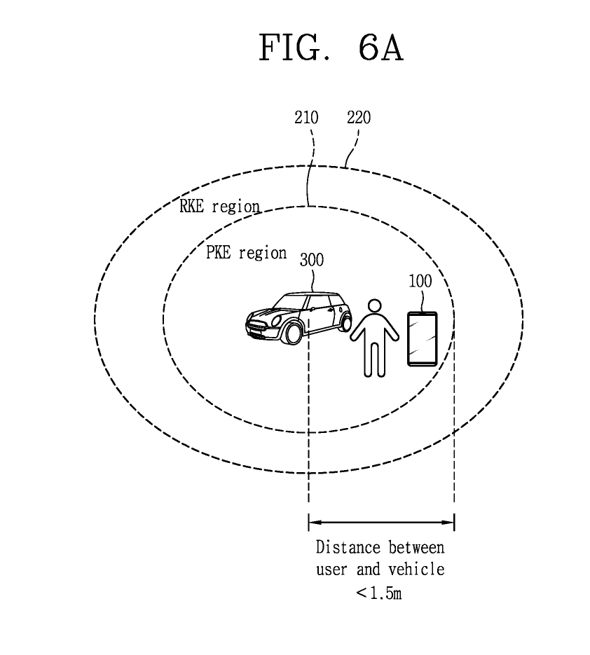

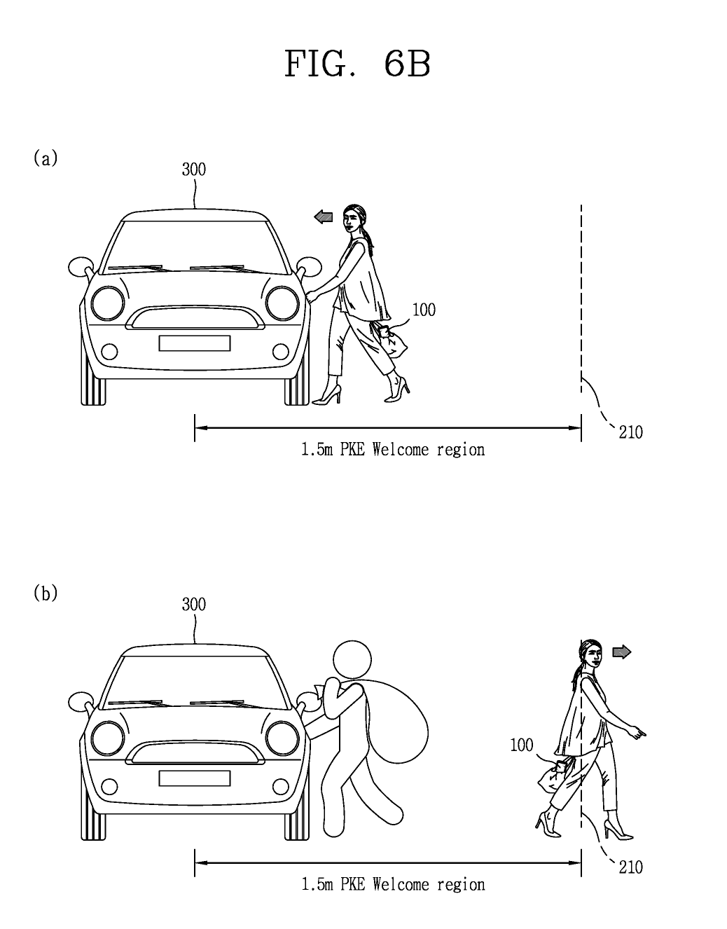

Referring to FIG. 6A, even when the mobile terminal 100 is present within the first region 210 capable of receiving a request signal associated with the vehicle with respect to the vehicle 300, two situations may occur. The first situation can be when the vehicle owner who possesses the mobile terminal performs a preset operation associated with the vehicle in the vehicle to control the vehicle.

Here, the preset operation associated with the vehicle can denote an operation for allowing the vehicle 300 to send a request signal associated with the vehicle among operations performed by a person in the vehicle 300. The vehicle 300 can send a request signal associated with the vehicle corresponding to the preset operation based on the preset operation being performed in the vehicle 300 or in the vicinity of the vehicle 300. The request signal may correspond to a low-frequency signal (or PKE signal) sent through the PKE function.

The preset operation associated with the vehicle will be substituted by the foregoing description. The second situation is when a preset operation is performed in the vehicle by another person before the vehicle owner having the mobile terminal moves out of the first region 210.

The second situation can be understood as while the vehicle owner is moving away from the vehicle after getting out of the vehicle, another person (e.g., thief, burglar) performs a preset operation prior to the mobile terminal 100 getting out of the first region with respect to the vehicle 300 to allow the vehicle to send a request signal associated with the vehicle, and acquires a control signal associated with the vehicle from the mobile terminal 100 that is present within the first region 210 to steal the vehicle.

The present invention provides a mobile terminal capable of defending the second situation and a control method thereof. Specifically, when the mobile terminal 100 exists within the first region 210 capable of receiving a request signal associated with the vehicle with respect to the vehicle 300, the controller 180 can determine whether or not to transmit a control signal associated with the vehicle based on the position trajectory of the mobile terminal acquired through the GPS module 115.

For example, when a request signal associated with the vehicle is received while the mobile terminal 100 exists within the first region 210, the controller 180 can determine whether or not to transmit a control signal associated with the vehicle based on the position trajectory of the mobile terminal (or a movement direction of the mobile terminal, a movement trajectory of the mobile terminal, a position change history of the mobile terminal, a position change information, a position change pattern, etc. of the mobile terminal).

The controller 180 can determine the position trajectory of the mobile terminal based on the location (or location information) of a plurality of mobile terminals acquired through GPS module 115 with the passage of time. In addition, the controller 180 can determine (judge) whether the mobile terminal moves closer to or away from the vehicle, based on the current location (location information) of the vehicle 300 and the position trajectory of the mobile terminal.

For example, as illustrated in FIG. 6B(a), when the mobile terminal 100 approaches the vehicle 300 while being present within the first region 210, the controller 180 can control the communication unit 110 to transmit a control signal associated with the vehicle in response to a request signal associated with the vehicle.

Specifically, when a request signal associated with the vehicle is sent from the vehicle 300 and received through the communication unit 110 as a preset operation is performed while the mobile terminal 100 exists in the first region 210, the controller 180 can determine the position trajectory of the mobile terminal (or a position trajectory or real-time position trajectory of the mobile terminal including a time point at which the request signal is received) prior to a time point at which the request signal is received.

When it is determined that the position trajectory of the mobile terminal approaches the vehicle 300, the controller 180 can transmit a control signal associated with the vehicle corresponding to the request signal. The vehicle 300 can receive the control signal, and perform an operation of the vehicle corresponding to the control signal.

FIG. 6B (a) can be applicable to the first situation described above. In another example, as illustrated in FIG. 6B(b), when the mobile terminal 100 moves away from the vehicle 300 while being present within the first region 210, the controller 180 can not respond a request signal associated with the vehicle or may not transmit (send) a control signal associated with even when the request signal is received.

Specifically, when a request signal associated with the vehicle is sent from the vehicle 300 and received through the communication unit 110 as a preset operation is performed while the mobile terminal 100 exists in the first region 210, the controller 180 can determine the position trajectory of the mobile terminal (or a position trajectory or real-time position trajectory of the mobile terminal including a time point at which the request signal is received) prior to a time point at which the request signal is received. When it is determined that the position trajectory of the mobile terminal moves away from the vehicle 300, the controller 180 may not transmit a control signal associated with the vehicle (or ignore the request signal) even when the request signal is received.

FIG. 6B(b) can be applicable to the second situation described above. In other words, the controller 180 can not transmit a control signal even when a request signal associated with the vehicle is received while the mobile terminal 100 is moving away from the vehicle within the first region 210, thereby preventing the vehicle from being stolen. Furthermore, when a request signal associated with the vehicle is received through the communication unit 110 while the mobile terminal 100 is present within the first region 210 while being moving away from the vehicle 300, the controller 180 can ask for a call connection to a preset caller ID (e.g., a police station caller ID, a local guard caller ID, or a previously set caller ID).

In addition, when a request signal associated with the vehicle is received through the communication unit 110 while the mobile terminal 100 is moving away from the vehicle 300 but still is within the first region 210, the controller 180 can activate the camera 121 to capture another person (thief). When the request signal associated with the vehicle is received through the communication unit 110 while the mobile terminal 100 is present within the first region 210, the controller 180 can send a control signal associated with the vehicle in response to the request signal.

Through the foregoing configuration, the present disclosure can provide a novel mobile terminal capable of receiving a request signal associated with the vehicle with respect to the vehicle 300 so as to prevent the theft of the vehicle even when the mobile terminal 100 is within the first region as well as out of the first region, and a control method thereof.

Further, the present disclosure can accurately determine the location of the vehicle in order to determine whether or not the mobile terminal 100 is present within a preset distance from the vehicle 300 (or whether or not the mobile terminal 100 is present within a first region capable of receiving a request signal associated with the vehicle with respect to the vehicle).

In general, when a preset operation associated with the vehicle is performed in the vehicle and a request signal associated with the vehicle is sent from the vehicle can occur while the vehicle is parked (or stopped). Accordingly, in the present specification, the location (or location information) of the vehicle can denote a place (or place information, coordinate, etc.) where the vehicle is currently parked.

The controller 180 of the mobile terminal 100 can determine the location (or location information) of the vehicle in various ways. For example, when a specific operation is performed in the vehicle (for example, any one or a combination of at least two of turning off a startup of the vehicle, locking a door of the vehicle or sensing that the driver gets off the vehicle, the controller 180) can determine (judge) the location information of the vehicle using the location of the mobile terminal acquired through the GPS module 115 when the location information of the vehicle is received from the vehicle 300 or the specific operation is performed in the vehicle.

In addition, the controller 180 can determine the location of the mobile terminal acquired through the GPS module 115 at a time point at which a preset signal is transmitted based on the preset signal associated with the vehicle being transmitted through the communication unit 110. For example, screen information (or a graphic interface) capable of controlling the vehicle can be displayed on the display unit 151 of the mobile terminal 100. The screen information can include a graphic object set to perform various functions associated with the vehicle.

For example, the screen information can include a graphic object associated with a function of turning off the vehicle, a graphic object associated with a function of locking a door of the vehicle, and the like. The preset signal can be a signal transmitted to the vehicle 300 through the communication unit 110 when the graphic object is selected (or touched).

For example, the predetermined signal can include all types of signals being transmitted to the vehicle through the mobile terminal when the vehicle has completed parking and the driver gets off the vehicle. Here, the preset signal can include at least one of control signals associated with the vehicle.

For example, the preset signal can include a signal controlling to turn off the startup of the vehicle or a signal controlling to lock a door of the vehicle. When the preset signal is transmitted to the vehicle 300 through the communication unit 110 by a user request (or a user's manipulation through the screen information), the controller 180 of the mobile terminal 100 can determine the location of the mobile terminal acquired through the GPS module 115 of the mobile terminal at the time of transmitting the preset signal as the location of the vehicle.

Further, upon receiving the preset signal from the mobile terminal, the vehicle 300 can transmit the location information of the vehicle acquired through the GPS module provided in the vehicle 300 to the mobile terminal 100. When the preset signal is transmitted through the communication unit 110 and then the location information of the vehicle is received from the vehicle 300, the controller 180 of the mobile terminal 100 can determine a location corresponding to the location information of the vehicle as the location of the vehicle.

Further, when the vehicle 300 enters an area (for example, within a building, an underground parking lot, a tunnel, a cloudy area, etc.) where it is not possible to receive GPS information, the GPS module provided in the mobile terminal and the GPS module provided in the vehicle has difficulty in acquiring an accurate current location.

In this instance, the present disclosure can acquire the location information of the vehicle in a preset manner from a point where GPS information is not received. For example, as illustrated in FIG. 7(a), the mobile terminal 100 and the vehicle 300 can acquire the locations of the mobile terminal 100 and the vehicle 300 using the GPS modules provided therein when the vehicle is driving.

At this time, as illustrated in FIG. 7(b), when it is sensed that the vehicle 300 enters a region 700 incapable of receiving GPS information, the mobile terminal 100 can transmit a control command controlling to recognize a location in the preset manner to the vehicle 300 through the communication unit 110. Furthermore, when it is sensed that the vehicle 300 enters the region 700 incapable of receiving GPS information, the vehicle 300 can start to recognize a location in a preset manner based on a control command received from the mobile terminal or the control of the controller of the vehicle.

Here, the preset manner can be understood as an indoor navigation function. As illustrated in FIG. 7(c), when GPS information is not received (or it is sensed that the vehicle 300 enters the region 700 incapable of receiving the GPS information), the controller 180 of the mobile terminal 100 can determine the location 710 of the mobile terminal that was acquired last. As illustrated in FIG. 7(c), when GPS information is not received (or it is sensed that the vehicle 300 enters the region 700 incapable of receiving the GPS information), the vehicle 300 can also determine the location 710 of the vehicle that was acquired last.

When an indoor navigation function is executed, the vehicle 300 can measure a number of revolutions of the vehicle's wheels, a steering direction of the vehicle's wheels, and the like from the time of executing the function. The vehicle 300 can store the radius information of the wheel in advance, and calculate a distance traveled by the vehicle 300 in a region incapable of receiving GPS information through the radius information and the number of revolutions of the wheel.

In addition, the vehicle 300 can calculate a direction in which the vehicle 300 moves in a region incapable of receiving GPS information based on the steering direction of the wheel. In other words, the preset method can be a method of determining a trajectory in which the vehicle actually has moved in the region 710 based on the number of revolutions of the vehicle's wheels and the steering direction of the vehicle's wheels, and the like.

In the preset method, a process of correcting a movement trajectory (or a moved distance or a moved direction) can be performed in consideration of a degree to which the wheel slides on the floor, an inertial sensor such as the MU, an encoder value of the two wheel axles, and the like. Further, even when the vehicle and the mobile terminal enter a region incapable of receiving GPS information, communication can be performed between the mobile terminal and the vehicle. Accordingly, the vehicle 300 can determine (acquire) the movement trajectory information of the vehicle 300 in a region incapable of receiving GPS information through the preset method.

Then, as illustrated in FIG. 7(d), a specific operation can be performed in the vehicle (for example, any one or a combination of at least two of turning off the startup of the vehicle, locking a door of the vehicle, and sensing that the driver gets off the vehicle) or a preset signal can be transmitted from the mobile terminal to the vehicle. Here, the predetermined signal can include all types of signals being transmitted to the vehicle through the mobile terminal when the vehicle has completed parking and the driver gets off the vehicle.

In addition, the preset signal can include at least one of control signals associated with the vehicle. For example, the preset signal can include a signal controlling to turn off the startup of the vehicle or a signal controlling to lock a door of the vehicle. In this instance, the vehicle 300 can transmit the movement trajectory information (or location information measured up to now) of the vehicle acquired through the preset method (indoor navigation function) to the mobile terminal 100.

As illustrated in FIG. 7(e), the controller 180 of the mobile terminal 100 can determine the current location information 720 of the vehicle using the movement trajectory information of the vehicle and the location information 710 of the vehicle/mobile terminal acquired when entering a region incapable of receiving the GPS information. In other words, the controller 180 can determine the final location of the vehicle using the location information 710 that has been finally acquired prior to entering the region 700 incapable of receiving GPS information and movement trajectory information determined (acquired, calculated, judged) in the region 700. The preset method can be executed in the mobile terminal 100 as well as in the vehicle 300.

For example, when the vehicle 300 enters the region 700, the mobile terminal 100 can receive a number of revolutions of the wheel, the radius information of the wheel, and the steering information of the wheel from the vehicle 300. Then, the controller 180 can determine (calculate, judge, acquire) the movement trajectory information of the vehicle 300 based on the number of revolutions of the wheel, the radius information of the wheel, and the steering information of the wheel received from the vehicle 300 with the location information 710 as a starting point.

Then, when a signal corresponding to a specific operation is received from the vehicle as the specific operation is performed in the vehicle 300 or a preset signal is transmitted to the vehicle 300 through the communication unit 110 by a user's manipulation, the controller 180 can determine the final location of the vehicle based on the movement trajectory information acquired up to now and the location information 710.

Through the foregoing configuration, the present disclosure can accurately acquire the final (or current) location of the vehicle even when the mobile terminal or the vehicle enters a region incapable of receiving GPS information. Furthermore, the present disclosure can provide a control method capable of more accurately determining whether or not the mobile terminal is present within the first region incapable of receiving a request signal associated with the vehicle, based on the location of the vehicle.

Further, when a signal corresponding to a specific operation is received from the vehicle as the specific operation is performed in the vehicle 300 or a preset signal is transmitted to the vehicle 300 through the communication unit 110 by a user's manipulation (in other words, when the vehicle is parked and the driver gets out of the vehicle), the controller 180 can acquire various information. For example, in a region incapable of receiving GPS information, the controller 180 can determine the final location of the vehicle based on movement trajectory information received from the vehicle. In another example, the controller 180 can acquire altitude information at the parked location of the vehicle using the pressure sensor (or altitude sensor) of the sensing unit 140.

In still another example, the controller 180 can acquire the type of a communication device (for example, WiFi, Beacon, AP) sensed at the parked location of the vehicle and the intensity information of a signal received from the relevant communication device. Furthermore, the controller 180 can capture an image adjacent to the parked location of the vehicle using the camera 121, and store it in the memory 170. In addition, the controller 180 can analyze the captured image to acquire object information adjacent to the parked location of the vehicle.

Various information as described above can be used as information for preventing (defending) a relay attack of a vehicle, and the information will be described later with reference to the accompanying drawings. In addition, the mobile terminal 100 according to an embodiment of the present disclosure can prevent a relay attack using various information as well as the location of the vehicle and the location of the mobile terminal.

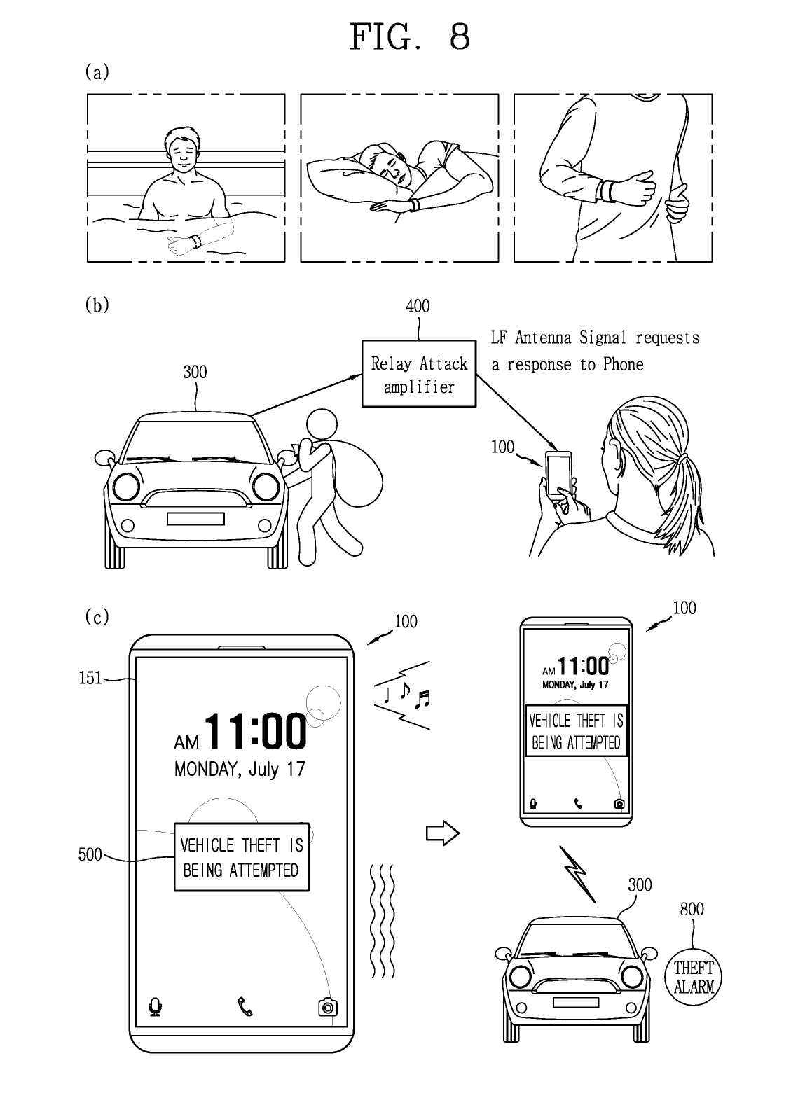

Hereinafter, a method of preventing a relay attack in various manners will be described in more detail with reference to the accompanying drawings. In particular, FIGS. 8-23 are conceptual views illustrating a method for preventing a relay attack of a vehicle using a mobile terminal according to an embodiment of the present disclosure.

A mobile terminal may extend to a wearable device that is wearable on a human body, beyond the dimensions in which the mobile terminal is mainly used by a user who grabs it with his or her hand. Examples of the wearable device include a smart watch, a smart glass, a head mounted display (HMD), and the like. Hereinafter, description will be given of examples of a mobile terminal extending to the wearable device. In other words, the mobile terminal of the present disclosure can be a wearable device.

A wearable device can exchange data with (or cooperate with) another mobile terminal 100. The short-range communication module 114 can sense (recognize) a wearable device capable of communicating with the mobile terminal in the vicinity of the mobile terminal 100. In addition, when the sensed wearable device is a device which is authenticated to communicate with the mobile terminal 100 according to the present disclosure, the controller 180 can transmit at least part of data processed in the mobile terminal 100 to the wearable device via the short-range communication module 114. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

In addition, the mobile terminal 100 according to the present disclosure can include a sensing unit 140 for sensing the movement of the mobile terminal. Upon receiving a request signal associated with the vehicle while the mobile terminal 100 moves in a preset movement, the controller 180 can not transmit (send) a control signal associated with the vehicle. For example, the predetermined movement may denote a movement other than a movement of the mobile terminal when the driver (vehicle owner) uses the vehicle. In other words, the predetermined movement may denote the movement of the mobile terminal sensed in a situation other than a situation where the driver can use the vehicle.

For example, when the mobile terminal 100 senses a preset movement (for example, a movement in the middle of swimming or showering, a movement in the middle of sleeping or a movement in the middle of exercise) or moves in the preset movement as illustrated in FIG. 8(a), the controller 180 can receive a request signal associated with the vehicle as illustrated in FIG. 8(b). In this instance, the controller 180 does not transmit a control signal associated with the vehicle corresponding to the received request signal (or ignore the received request signal).

The movement information (or data) or movement pattern information corresponding to the preset movement can be stored in the memory 170 in advance. Further, the movement information (or movement pattern information) corresponding to the preset motion may denote the movement information of the mobile terminal sensed in a situation other than a situation where the driver can use the vehicle, and the movement information can be stored in advance for each different situation.

For example, the different situations can include various situations, such as a movement in the middle of swimming or showering, a movement in the middle of sleeping, a movement in the middle of exercise, or the like). Furthermore, the controller 180 can receive movement information or movement pattern information corresponding to the preset movement from an external server (for example, the Internet, an external device, or the like) through the communication unit 110.

When movement information sensed through the sensing unit 140 corresponds to movement information corresponding to the preset motion, the controller 180 can determine (judge, extract, sense, detect) that the mobile terminal moves in the preset movement. Further, as illustrated in FIG. 8(b), when the mobile terminal moves in the preset movement, the mobile terminal 100 has a high probability of being located at a place out of the first region 210 capable of receiving a request signal associated with the vehicle from the vehicle 300.

Accordingly, receiving information associated with the vehicle while the mobile terminal moves in the preset movement has a high probability of attempting a relay attack using the amplifier 400. As a result, when a request signal associated with the vehicle is received through the sensing unit 140 while the mobile terminal moves in a preset movement, the controller 180 can ignore the request signal or may not transmit a control signal associated with the vehicle corresponding to the request signal.

Furthermore, when a request signal associated with the vehicle is received through the sensing unit 140 while the mobile terminal is moving in a preset movement, the controller 180 can output notification information 500 indicating that there is a theft attempt of the vehicle through the output unit 150 as illustrated in FIG. 8(c). In addition, when a request signal associated with the vehicle is received through the sensing unit 140 while the mobile terminal moves in a preset movement, the controller 180 can transmit a control command for controlling the vehicle 300 to output an alarm through the communication unit 110 to the vehicle 300.

When a request signal associated with the vehicle is received through the sensing unit 140 while the movement of the mobile terminal is not sensed, the controller 180 can not transmit a control signal associated with the vehicle.

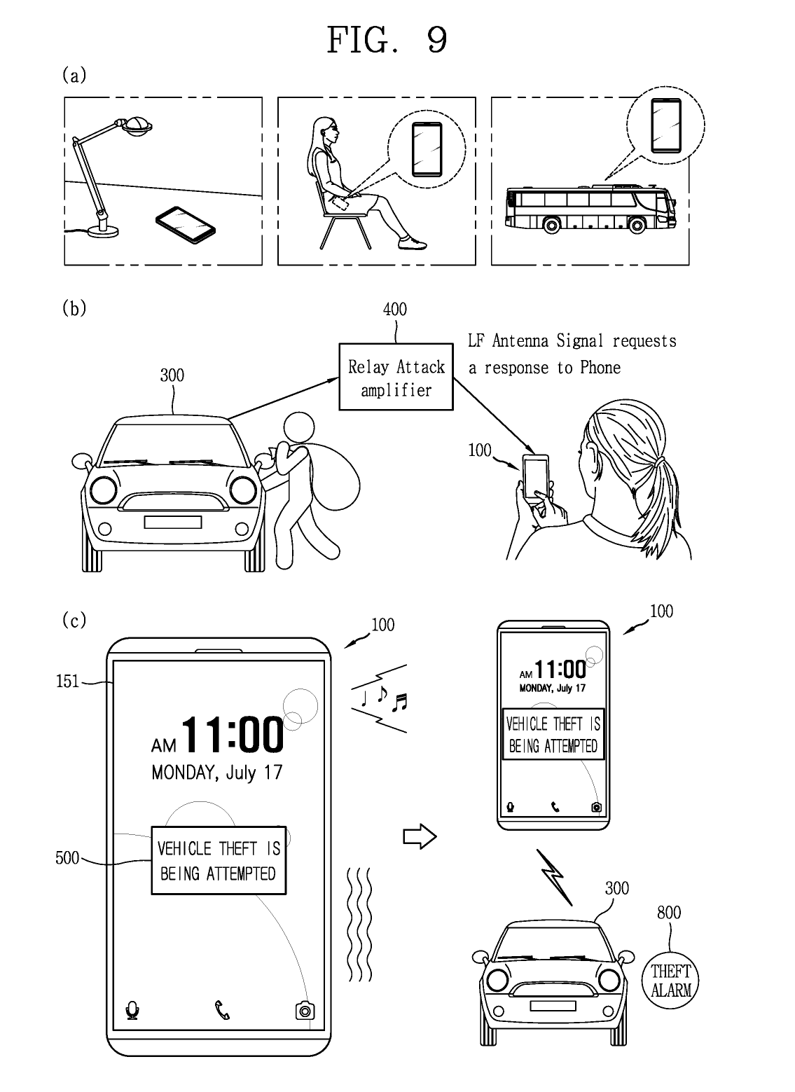

For example, as illustrated in FIG. 9(a), the movement of the mobile terminal not being sensed can include when the mobile terminal is placed on a position while the driver does not possesses the mobile terminal, when the driver does not move while the driver possesses the mobile terminal, and the like.

The movement of the mobile terminal not being sensed can denote when the driver does not have an intension to control the vehicle. Accordingly, there is a high probability that the mobile terminal exists in a region out of the first region 210 capable of receiving a request signal associated with the vehicle, which is sent from the vehicle 300. In other words. receiving a request signal associated with the vehicle while the movement of the mobile terminal is not sensed, as illustrated in FIG. 9(b), has a high probability that a relay request by the amplifier 400 is being attempted.

In this instance, when a request signal associated with the vehicle is received through the sensing unit 140 while the movement of the mobile terminal is not sensed, the controller 180 can not transmit a control signal associated with the vehicle. Similarly, as illustrated in FIG. 9(c), when a request signal associated with the vehicle is received through the sensing unit 140 while the movement of the mobile terminal is not sensed, the controller 180 can output notification information 500 indicating that there is an attempted theft of the vehicle through the output unit 150 or transmit a control command for controlling the vehicle 300 to output an alarm to the vehicle 300 through the communication unit 110.

Further, as illustrated in FIG. 9(a), when the driver rides a public transportation, the mobile terminal can be moved in a preset movement or the movement of the mobile terminal may not be sensed. In this state, when a request signal associated with the vehicle is received through the communication unit 110, the controller 180 can ignore the request signal or may not transmit the control signal.

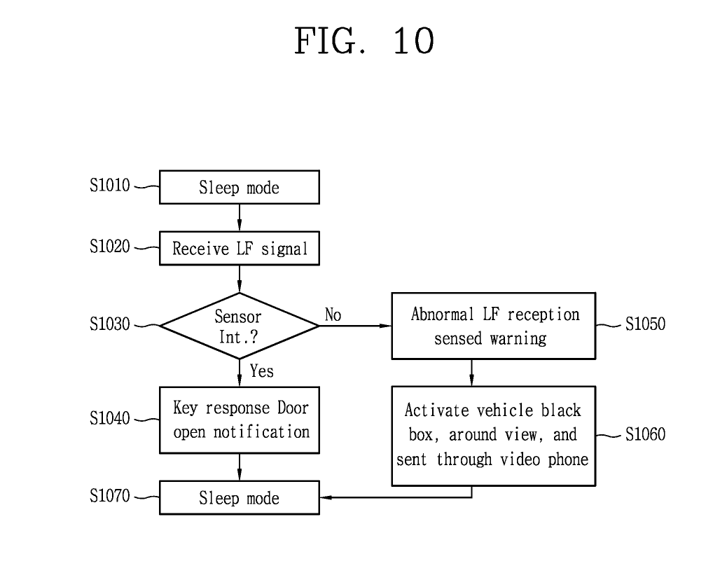

The description illustrated in FIG. 9 will be described with reference to a flowchart in FIG. 10. According to the flowchart in FIG. 10, the mobile terminal of the present disclosure can determine whether or not a request signal (low-frequency signal) associated with the vehicle is received as a relay attack is attempted.

For example, the mobile terminal 100 can be in a sleep state (or standby state) (S1010). In this state, the controller 180 can receive a request signal (low-frequency signal) associated with the vehicle through the communication unit 110 (S1020). The controller 180 can activate the sensing unit 140 to sense the movement of the mobile terminal. At this time, it can be determined whether the movement of the mobile terminal is sensed (S1030). Specifically, the controller 180 can determine whether or not the movement of the mobile terminal has occurred (interrupted, int.) using the sensing unit 140.

When the movement of the mobile terminal is sensed, the controller 180 can transmit a control signal corresponding to the request signal in response to the request signal associated with the vehicle (S1040). Specifically, when the movement of the mobile terminal is sensed and the movement is not the foregoing preset movement (in other words, when it is a movement of the driver desired to control the vehicle), the controller 180 can send a control signal corresponding to the request signal in response to the request signal associated with the vehicle.

In addition, when a request signal associated with the vehicle is received while the movement of the mobile terminal is not sensed, the controller 180 can not transmit a control signal associated with the vehicle. In addition, when a request signal associated with the vehicle is received while the movement of the mobile terminal is not sensed, the controller 180 can output notification information indicating that a request signal associated with the vehicle is abnormally received (or notification information indicating that a theft of the vehicle (relay attack) is being attempted) through the output unit (S1050).

Then, when a request signal associated with the vehicle is received while the movement of the mobile terminal is not sensed, the controller 180 can activate a black box provided in the vehicle or transmit a control command for activating an AVM camera (Around View Monitor camera) to the vehicle 300 through the communication unit 110.

Then, the controller 180 can receive an image captured through the black box or the AVM camera from the vehicle 300 through the communication unit 110 (S1060). Further, when a request signal associated with the vehicle is received while the movement of the mobile terminal is not sensed, the controller 180 can transmit a control command for controlling the vehicle 300 to output an alarm to the vehicle 300 through the communication unit 110.

Then, the mobile terminal 100 can enter a sleep state (or standby state) (S1070). In addition, the mobile terminal according to the present disclosure can provide a user interface capable of preventing a theft of the vehicle (relay attack) based on a function (or application) being executed in the mobile terminal, and a control method thereof.

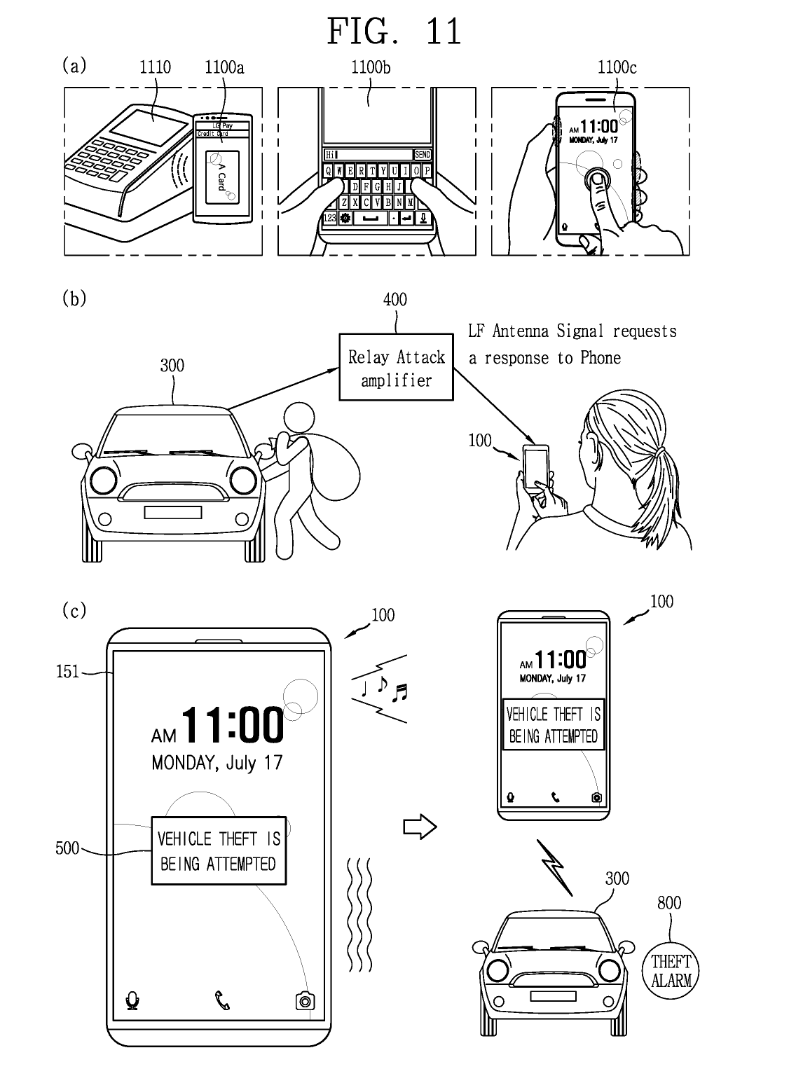

For example, as illustrated in FIG. 11, the controller 180 can not transmit a control signal associated with the vehicle when a request signal associated with the vehicle is received while a preset function is being executed. Here, the preset function may denote a function or application in which the driver is not associated with the vehicle.

For example, as illustrated in FIG. 11(a), the preset function can include when a payment function through a POS terminal 1110 is being executed (1100a), when a two-handed keyboard (keypad) is activated (1100b), when a user input is being received through a two-handed keyboard, when a driver is holding the mobile terminal with one hand while applying a touch 1100c to the display unit 151 with another hand, and the like.

In other words, the preset function being executed may denote when there is no intention of the driver to control the vehicle or when the driver is unable to control the vehicle. Similarly, a request signal associated with the vehicle being received while the preset function is being executed has a high probability that the request signal associated with the vehicle is received by the amplifier 400 when the mobile terminal 100 is out of the first region 210 capable of receiving the request signal associated with the vehicle from the vehicle 300 as illustrated in FIG. 11(b).

Accordingly, when a request signal associated with the vehicle is received while the preset function is being executed, the controller 180 can ignore the request signal or not transmit a control signal associated with the vehicle corresponding to the request signal. When a request signal associated with the vehicle is received through the sensing unit 140 while the preset function is being executed, the controller 180 can output notification information 500 indicating that there is a theft attempt of the vehicle through the output unit 150 as illustrated in FIG. 11(c).

In addition, when a request signal associated with the vehicle is received through the sensing unit 140 while the mobile terminal moves in a preset movement, the controller 180 can transmit a control command for controlling the vehicle 300 to output an alarm through the communication unit 110 to the vehicle 300.

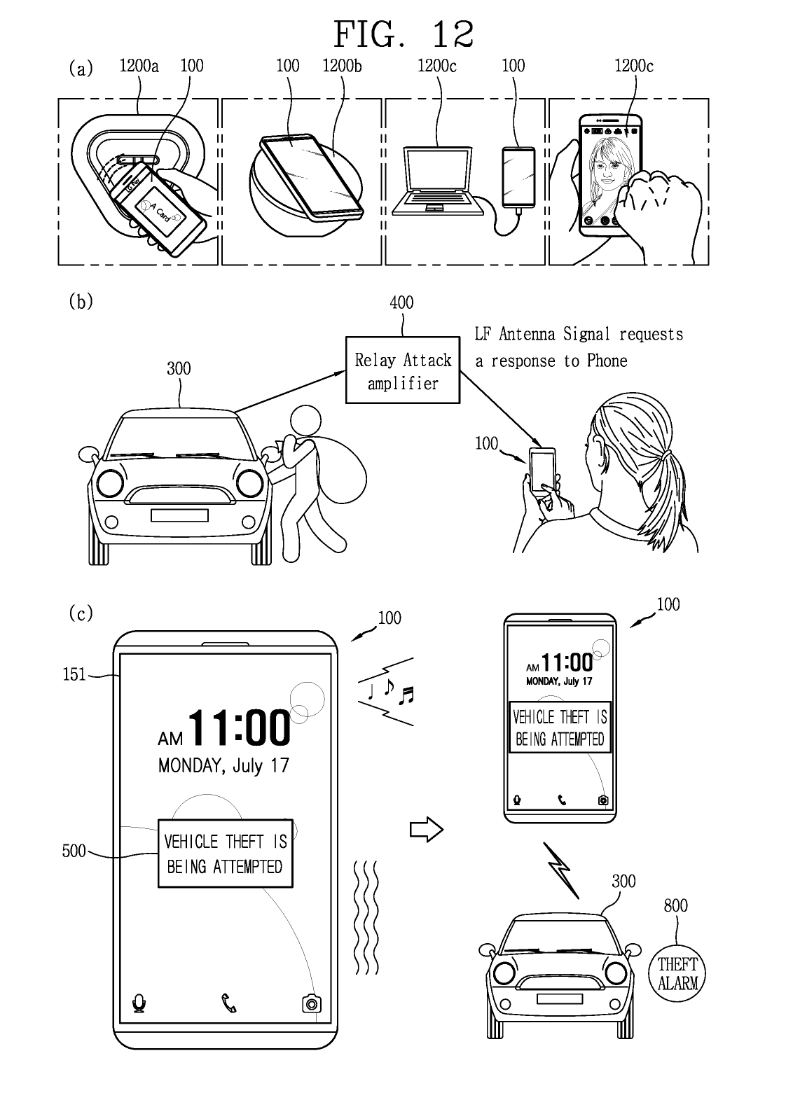

Further, as illustrated in FIG. 12(a), when a request signal associated with the vehicle is received through the communication unit 110 while the mobile terminal performs a preset operation, the controller 180 can not transmit a control signal associated with the vehicle. The preset operation can include an operation in which the driver is unable to control the vehicle.

For example, as illustrated in FIG. 12(a), the preset operation can include an operation of performing NFC communication (or payment using NFC) through an NFC function of the mobile terminal, an operation in which the mobile terminal is being charged in a wireless manner, an operation in which the mobile terminal is being connected in a wired manner to an external device 1200c (for example, a notebook, a PC or the like) through the interface unit 160 or a state where the camera 121 is activated or a state where the camera 121 is activated and a capture function by an operation of a user is being performed, and the like.

In other words, receiving a request signal associated with the vehicle while the mobile terminal performs a preset operation, as illustrated in FIG. 12(b), has a high probability that a relay request by the amplifier 400 is being attempted. In this instance, when a request signal associated with the vehicle is received while the mobile terminal performs a preset operation, the controller 180 can not transmit a control signal associated with the vehicle.

Similarly, as illustrated in FIG. 12(c), when a request signal associated with the vehicle is received while the mobile terminal performs a preset operation, the controller 180 can output notification information 500 indicating that there is an attempted theft of the vehicle through the output unit 150 or transmit a control command for controlling the vehicle 300 to output an alarm to the vehicle 300 through the communication unit 110.

Further, the mobile terminal of the present disclosure can prevent vehicle theft (relay attack) based on an atmospheric pressure at the point where the mobile terminal is currently located and an atmospheric pressure at the time the vehicle was parked. Specifically, the sensing unit 140 of the mobile terminal of the present disclosure can sense an atmospheric pressure (or altitude). For example, the controller 180 can measure an altitude based on an atmospheric pressure measured through the sensing unit 140.

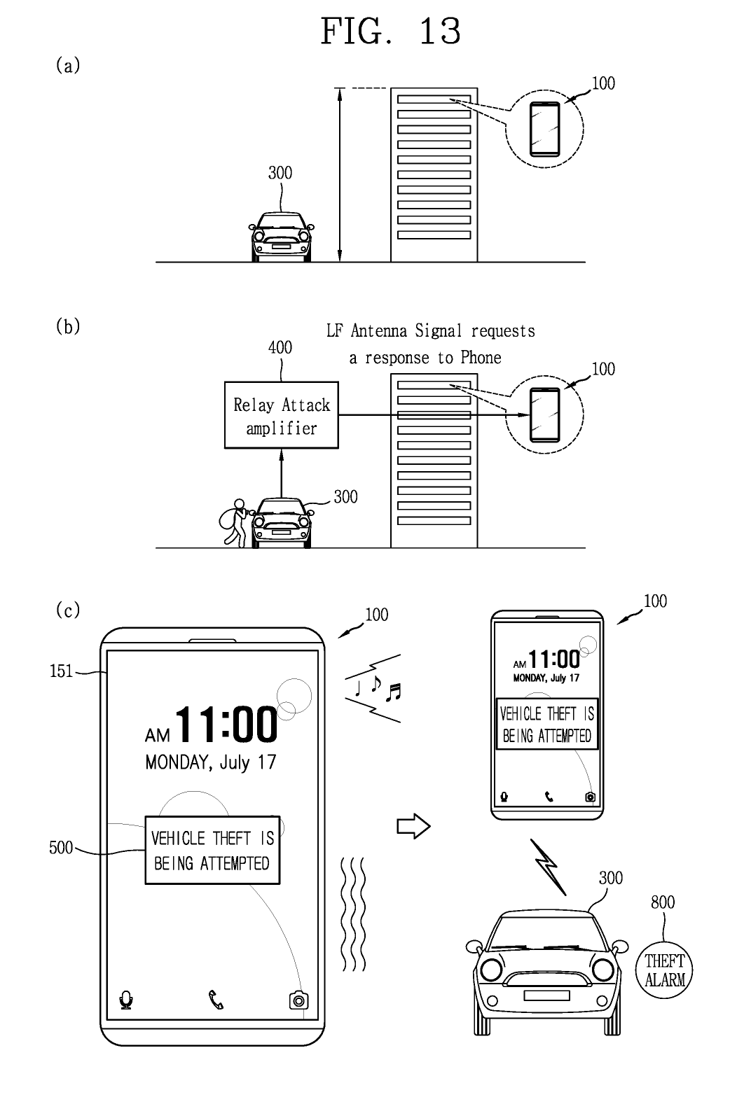

The controller 180 can sense a first atmospheric pressure when the vehicle is parked as illustrated in FIG. 13(a). The parking is completed when a specific operation is performed in the vehicle or when a preset signal associated with the vehicle is transmitted to the vehicle through the communication unit from the mobile terminal. The first atmospheric pressure is a value measured at the mobile terminal, but it is an atmospheric pressure when the parking of the vehicle is completed, and thus can be understood as an atmospheric pressure at the current location of the vehicle.

In other words, when it is sensed that the parking of the vehicle is completed, the controller 180 can sense the first atmospheric pressure through the sensing unit 140, and determine the first atmospheric pressure as an atmospheric pressure at the current location of the vehicle. The specific operation and the preset signal will be substituted by the foregoing description.

Furthermore, the controller 180 can sense a second atmospheric pressure through the sensing unit 140 when a request signal related to the vehicle is received through the communication unit 110. The second atmospheric pressure can be an atmospheric pressure measured after a predetermined time from a time point at which the first atmospheric pressure is measured.

Here, the second atmospheric pressure may denote an atmospheric pressure at the point where the mobile terminal is currently located. When the first and second atmospheric pressures differ by above a predetermined value, the controller 180 can ignore the request signal or may not transmit a control signal associated with the vehicle corresponding to the request signal.

Difference between the first and second pressures by above a predetermined value may denote that as illustrated in FIG. 13(b), a position of the vehicle 300 and a current location of the mobile terminal 100 differ by above a predetermined height. In this instance, the driver does not intend to control the vehicle in most cases, and a situation in which the request signal associated with the vehicle is received in this state means that a vehicle theft (relay attack) using the amplifier 400 is being attempted.

In this instance, when a request signal associated with the vehicle is received while the first and second atmospheric pressures differ by above a predetermined value (or the vehicle and the mobile terminal differ by above a predetermined height), the controller 180 can not transmit a control signal associated with the vehicle (or may ignore the request signal).

Similarly, as illustrated in FIG. 13(c), when a request signal associated with the vehicle is received while the first and second atmospheric pressures differ by above a predetermined value, the controller 180 can output notification information 500 indicating that there is an attempted theft of the vehicle through the output unit 150 or transmit a control command for controlling the vehicle 300 to output an alarm to the vehicle 300 through the communication unit 110.

Further, the controller 180 determines whether to transmit a control signal associated with the vehicle corresponding to the request signal associated with the vehicle through the communication unit 110, based on whether or not there is a change in the atmospheric pressure sensed through the sensing unit 140.

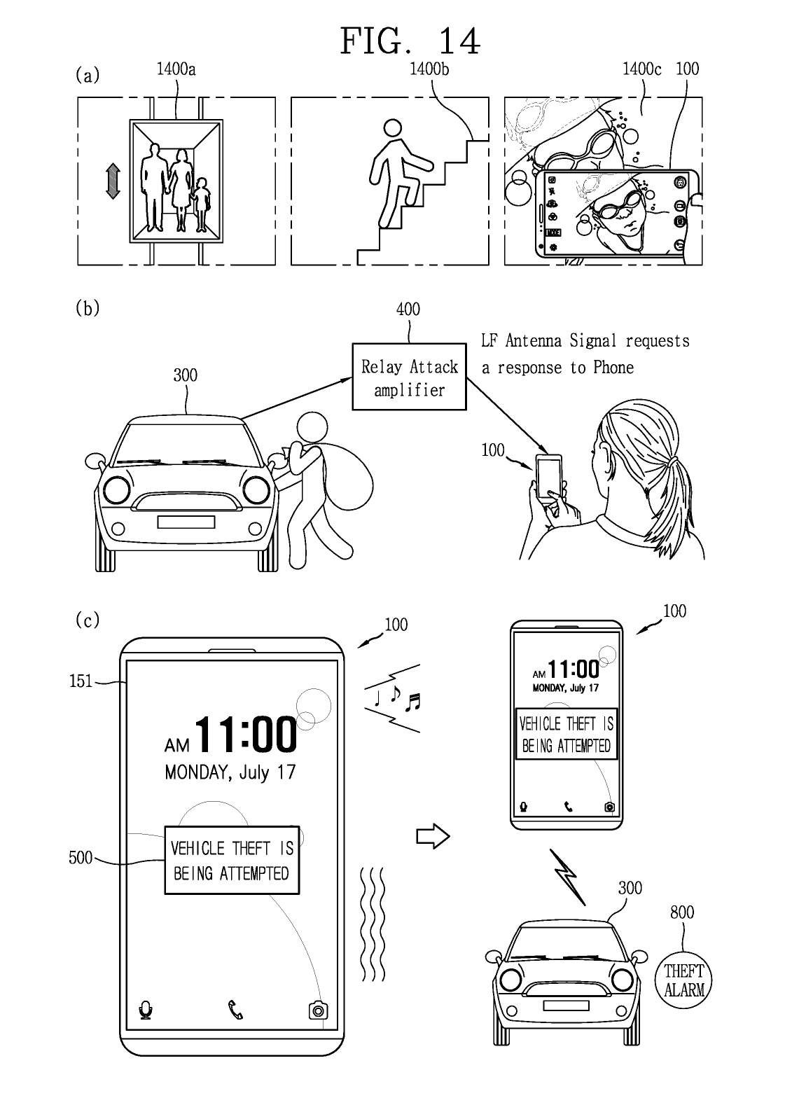

For example, as illustrated in FIG. 14(a), when a request signal associated with the vehicle is received through the communication unit 110 while the atmospheric pressure sensed through the sensing unit 140 is being changed, the controller 180 can not transmit a control signal associated with the vehicle. For example, the situation in which the atmospheric pressure is changed can include a situation in which the mobile terminal 100 moves upward or downward along a lift (elevator) 1400a, when the mobile terminal 100 moves into the water 1400c or moves up and down in the water while performing an operation of changing the height such as a step, an escalator 1400b or climbing a mountain, and the like as illustrated in FIG. 14(a).

In this instance, the driver mostly does not intend to control the vehicle or is mostly in a situation incapable of controlling the vehicle. The reception of a request signal associated with the vehicle in this state may denote that a vehicle theft (relay attack) using the amplifier 400 is being attempted as illustrated in FIG. 14(b). In this instance, when a request signal associated with the vehicle is received while the atmospheric pressure sensed through the sensing unit 140 is changed, the controller 180 can not transmit a control signal associated with the vehicle (or ignore the request signal).

Similarly, as illustrated in FIG. 14(c), when a request signal associated with the vehicle is received through the sensing unit 140 while the atmospheric pressure sensed through the sensing unit 140 is changed, the controller 180 can output notification information 500 indicating that there is an attempted theft of the vehicle through the output unit 150 or transmit a control command for controlling the vehicle 300 to output an alarm to the vehicle 300 through the communication unit 110.

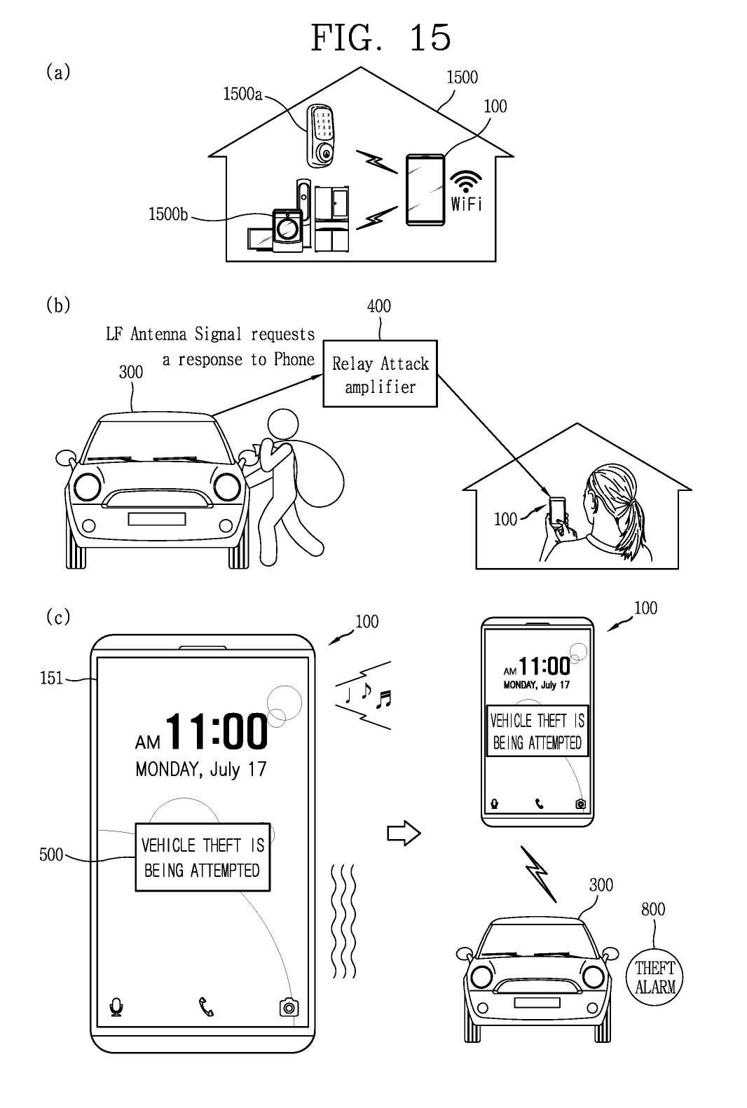

Further, in recent years, with the development of IoT (Internet of Things) technologies, it is possible to make a communication connection with various devices using a mobile terminal, and control a device connected thereto through communication using the mobile terminal. For example, as illustrated in FIG. 15(a), the mobile terminal 100 can be connected to communicate with at least one external device 1500a, 1500b provided at home 1500.

When a request signal associated with the vehicle is received through the communication unit 110 while communication is established to communicate with an external devices 1500a, 1500b, the controller 180 can not transmit a control signal associated with the vehicle. For example, when communication is established for the mobile terminal to communicate with an external device provided home 1500 may mostly include when the driver is at home.

In this instance, the driver mostly does not intend to control the vehicle or is mostly in a situation incapable of controlling the vehicle. The reception of a request signal associated with the vehicle in this state may denote that a vehicle theft (relay attack) using the amplifier 400 is being attempted as illustrated in FIG. 15(b). In this instance, when a request signal associated with the vehicle is received while communication is established to communicate with an external device 1500a, 1500b, the controller 180 may not transmit a control signal associated with the vehicle (or ignore the request signal).

Similarly, as illustrated in FIG. 15(c), when a request signal associated with the vehicle is received through the sensing unit 140 while communication is established to communicate with an external device 1500a, 1500b, the controller 180 can output notification information 500 indicating that there is an attempted theft of the vehicle through the output unit 150 or transmit a control command for controlling the vehicle 300 to output an alarm to the vehicle 300 through the communication unit 110.

Further, the controller 180 can determine a time zone that uses the vehicle based on a history in which a signal associated with the vehicle is transmitted and received. Here, the signal associated with the vehicle can include at least one of a signal corresponding to a specific operation transmitted from the vehicle 300 to the mobile terminal 100 as the specific operation is performed in the vehicle 300 and a signal corresponding to a preset signal associated with the vehicle transmitted from the mobile terminal 100 to the vehicle 300.

The controller 180 can determine a time zone in which the driver uses the vehicle based on a time at which a signal associated with the vehicle is transmitted and received. When a request signal associated with the vehicle is received at a time other than the determined time zone, the controller 180 can not transmit a control signal associated with the vehicle.

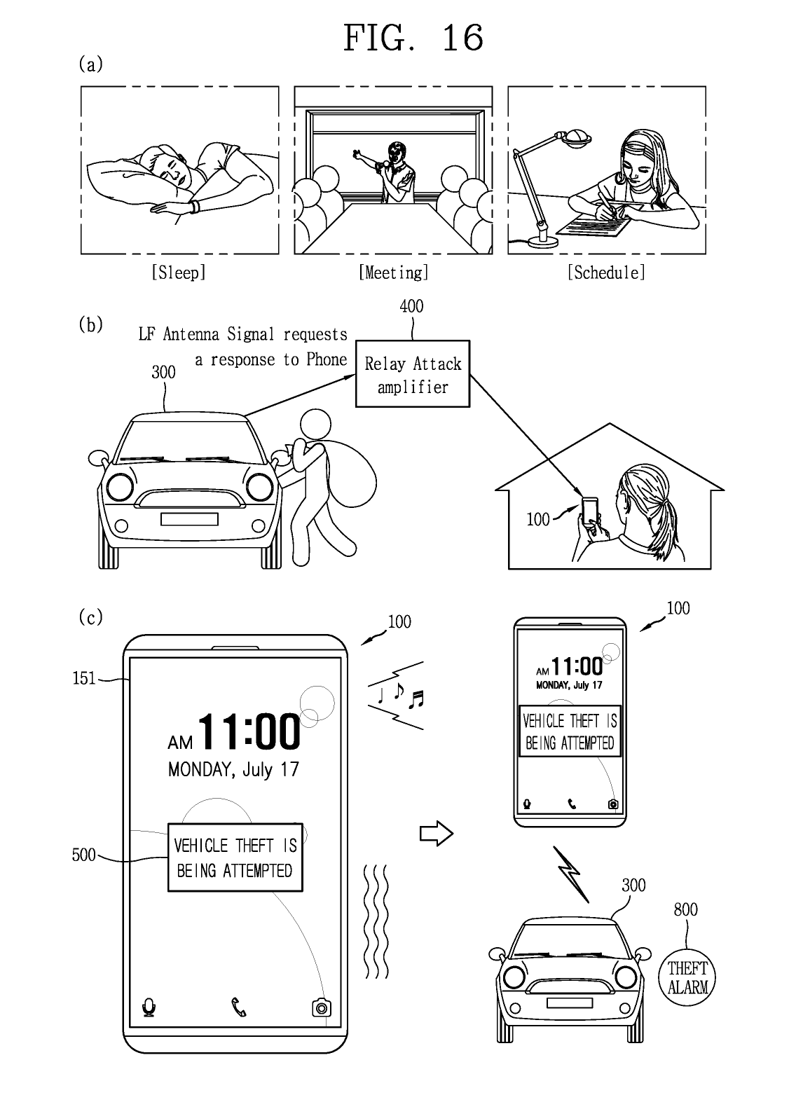

For example, the time other than the determined time zone can include a sleeping time zone, a meeting (work) time zone, or a schedule (class, lecture, etc.) time zone, as illustrated in FIG. 16(a). In other words, the controller 180 can determine time zones for performing other tasks other than a time zone that uses the vehicle, based on schedule information entered by the user.

The fact that a request signal associated with the vehicle is received at a time other than the time zone that uses the vehicle (or in a time zone that performs other tasks) may denote that the driver does not intend to control the vehicle or is in a situation incapable of controlling the vehicle. The reception of a request signal associated with the vehicle in this state may denote that a vehicle theft (relay attack) using the amplifier 400 is being attempted as illustrated in FIG. 16(b). In this instance, when a request signal associated with the vehicle is received at a time other than the time zone that uses the vehicle (or in a time zone that performs other tasks), the controller 180 may not transmit a control signal associated with the vehicle (or ignore the request signal).

Similarly, as illustrated in FIG. 16(c), when a request signal associated with the vehicle is received at a time other than the time zone that uses the vehicle (or in a time zone that performs other tasks), the controller 180 can output notification information 500 indicating that there is an attempted theft of the vehicle through the output unit 150 or transmit a control command for controlling the vehicle 300 to output an alarm to the vehicle 300 through the communication unit 110. In addition, the mobile terminal according to an embodiment of the present disclosure can measure a distance between the mobile terminal and the vehicle in various ways.

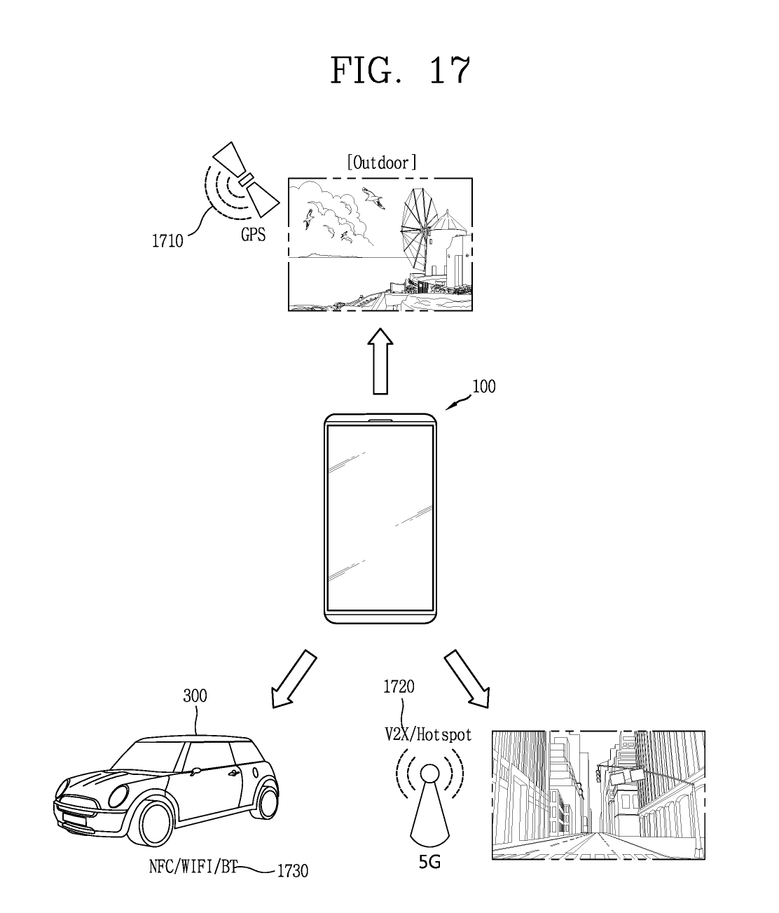

Referring to FIG. 17, according to a first example, when the vehicle and the mobile terminal are present at an outside capable of efficiently receiving GPS information, the location of the vehicle and the location of the mobile terminal can be determined based on the GPS information received from a GPS satellite 1710. According to a second example, when the vehicle and the mobile terminal are present at a place where the reception of the GPS information is unstable (for example, in an urban area, a place with many people, etc.), the location of the vehicle and the location of the mobile terminal can be determined based on the intensity of a signal received from an infrastructure (for example, V2X communication device, hotspot or the like) installed in an urban area as illustrated in FIG. 17.

According to a third example, when the vehicle and the mobile terminal are present at a place (for example, an underground parking lot, within a building, a tunnel, etc.) incapable of receiving GPS information, the vehicle can be connected to the mobile terminal through a short-range communication module (e.g., an NFC module, a WiFi module, a Bluetooth (BT) module, etc.) to determine a distance (or distance change) between the vehicle and the mobile terminal based on the intensity of a signal received through the short-range communication module.

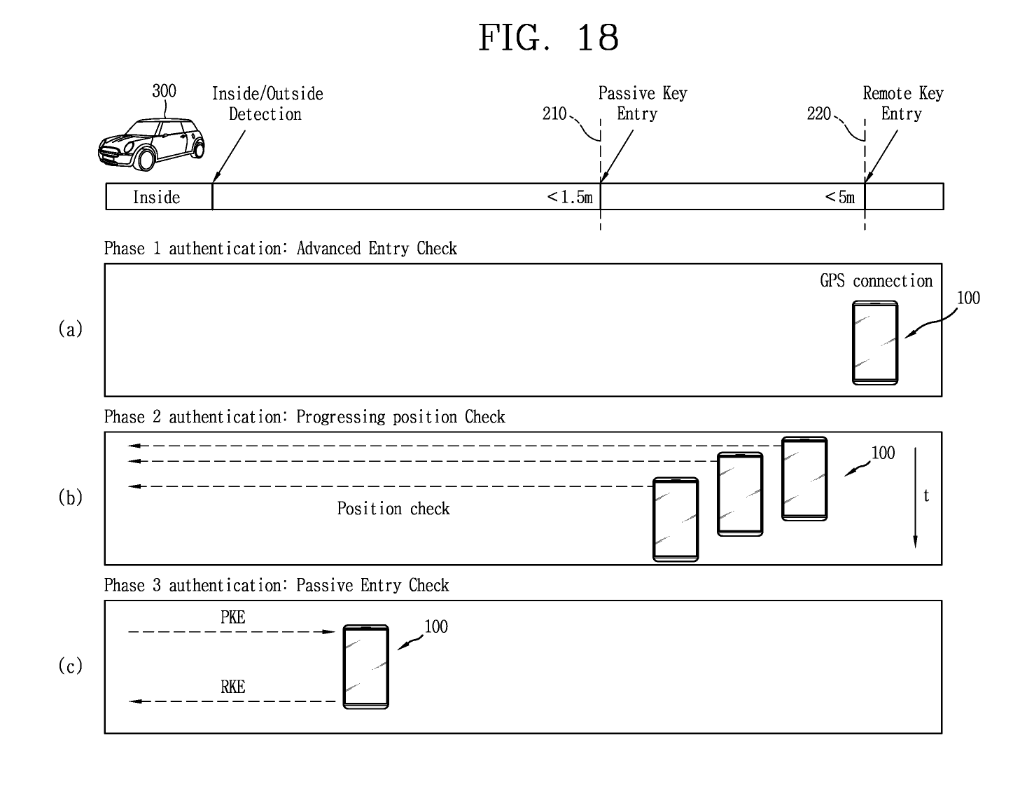

More specifically considering the first example, when GPS information is received through the GPS module 115 of the communication unit 110, the controller 180 of the mobile terminal can be connected to a GPS satellite as illustrated in FIG. 18(a). The connection with the GPS satellite can include the meaning of acquiring GPS information from the GPS satellite. The connection with the GPS satellite can be performed while the vehicle is present in a region (for example, second region 220) out of the first region 210 capable of receiving a request signal (low-frequency signal) associated with the vehicle sent from the vehicle.

Then, the controller 180 can acquire the location of the mobile terminal through the GPS information, and as illustrated in FIG. 18(b), determine whether or not the mobile terminal approaches the vehicle based on a location change of the mobile terminal acquired according to the flow of time (t). Then, as illustrated in FIG. 18(c), when it is sensed that the mobile terminal has entered the first region 210 subsequent to approaching the vehicle, the controller 180 can send a control signal corresponding to a request signal in response to the request signal associated with the vehicle received from the vehicle. More specifically considering the second example, the present disclosure can prevent a relay attack based on whether or not the vehicle or the mobile terminal is present within a distance capable of communicating with the infrastructure 1720.

In FIG. 19, it is assumed that the vehicle and the mobile terminal (or vehicle key module) are present within a region 1900 in which the vehicle and the mobile terminal (or vehicle key module) can communicate with the infrastructure 1720 at the time when the vehicle has completed parking. For example, the mobile terminal 100 can be in a sleep state (or standby state) (S1910). In this state, the controller 180 can receive a request signal (low-frequency signal) associated with the vehicle through the communication unit 110 (S1920).

When the request signal is received, the controller 180 can determine whether or not the mobile terminal 100 (or vehicle key module 200) and the vehicle 300 are present within the region 1900 capable of communicating with the infrastructure through the communication unit 110 (S1930). When the mobile terminal 100 (or vehicle key module 200) and the vehicle 300 are present within the region 1900 capable of communicating with the infrastructure, the controller 180 can send a control signal corresponding to a request signal in response to the request signal associated with the vehicle (S1940).

Further, when a request signal associated with the vehicle is received while at least one of the mobile terminal 100 (or vehicle key module 200) and the vehicle 300 is not present within the region 1900 capable of communicating with the infrastructure, the controller 180 can not transmit a control signal associated with the vehicle.

Furthermore, when a request signal associated with the vehicle is received while at least one of the mobile terminal 100 (or vehicle key module 200) and the vehicle 300 is not present within the region 1900 capable of communicating with the infrastructure, the controller 180 can output notification information indicating that the request signal associated with the vehicle is abnormally received (or notification information indicating that a vehicle theft (relay attack) is being attempted) through the output unit (S1950).

Then, when a request signal associated with the vehicle is received while at least one of the mobile terminal 100 (or vehicle key module 200) and the vehicle 300 is not present within the region 1900 capable of communicating with the infrastructure, the controller 180 can activate a black box provided in the vehicle or transmit a control command for activating an AVM camera (Around View Monitor camera) to the vehicle 300 through the communication unit 110.

Then, the controller 180 can receive an image captured through the black box or the AVM camera from the vehicle 300 through the communication unit 110 (S1960). Further, when a request signal associated with the vehicle is received while the movement of the mobile terminal is not sensed, the controller 180 can transmit a control command for controlling the vehicle 300 to output an alarm to the vehicle 300 through the communication unit 110.

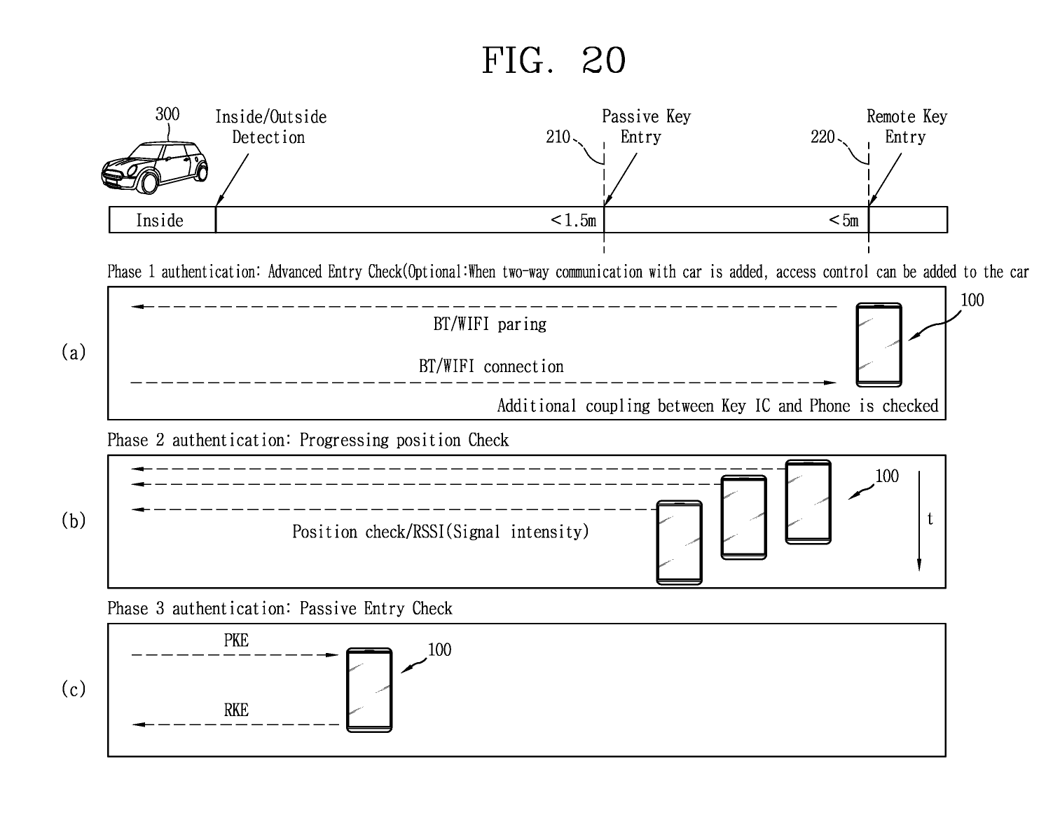

Then, the mobile terminal 100 can enter a sleep state (or standby state) (S1970). More specifically considering the third example, the controller 180 of the mobile terminal can be connected to a short-range communication device (for example, NFC, WiFi, BT (BLE)) to be communicable in a wireless manner as illustrated in FIG. 20(a).

A distance communicably connected through the short-range communication module can be larger than an available distance of the request signal associated with the vehicle sent from the vehicle. That is, the mobile terminal 100 and the vehicle 300 can be connected by short-distance communication even when the mobile terminal 100 is present at a position out of the first region 210 with respect to the vehicle 300.

In other words, the connection between the mobile terminal and the vehicle through short-range communication can be performed while the vehicle is present in a region (for example, second region 220) out of the first region 210 capable of receiving a request signal (low-frequency signal) associated with the vehicle sent from the vehicle, for example.

Then, the controller 180 can receive a signal (e.g., a short distance communication signal) transmitted from the vehicle at regular time intervals (or periodically) from the vehicle 300 as illustrated in FIG. 20(b). When the vehicle 300 is connected to the mobile terminal 100 for short-distance communication, the vehicle 300 can transmit a short-distance communication signal to the mobile terminal at regular time intervals (or periodically).

When the location of the mobile terminal cannot be acquired through the GPS module, the controller 180 can determine a distance between the vehicle and the mobile terminal based on the intensity of a signal transmitted from the vehicle. For example, as illustrated in FIG. 20(b), the controller 180 can determine a distance between the vehicle and the mobile terminal based on the intensity of a signal transmitted from the vehicle acquired according to the flow of time (t).

The intensity of a signal transmitted from the vehicle increases as a distance between the mobile terminal and the vehicle decreases. The controller 180 can determine whether or not the mobile terminal approaches the vehicle based on the intensity (or intensity change) of a signal transmitted from the vehicle. For example, the controller 180 can determine that the mobile terminal approaches the vehicle when the intensity of the signal transmitted from the vehicle gradually increases.

Then, as illustrated in FIG. 20(c), when it is sensed that the mobile terminal has entered the first region 210 subsequent to approaching the vehicle, the controller 180 can send a control signal (RKE signal) corresponding to a request signal (PKE signal) in response to the request signal associated with the vehicle received from the vehicle.

Further, as illustrated in FIG. 21, the vehicle 300 can include an NFC tag 2100, and the mobile terminal can include a communication unit 110 configured to communicate with the NFC tag 2100. The NFC tag 2100 and the communication unit may perform mutual communication based on proximity within a few centimeters. Referring to FIG. 21, the controller 180 of the mobile terminal 100 according to the present disclosure can transmit a control signal associated with the vehicle based on the reception of a request signal associated with the vehicle subsequent to communicating with the NFC tag 2100 through the communication unit 110.

If a request signal associated with the vehicle is received from the vehicle while the communication with the NFC tag 2100 is not performed through the communication unit 110, the controller 180 can ignore the request signal or may not transmit a control signal associated with the vehicle corresponding to the request signal. Through the foregoing configuration, the present disclosure can provide a mobile terminal capable of preventing a relay attack using various functions or various configurations of the mobile terminal, and a control method thereof.

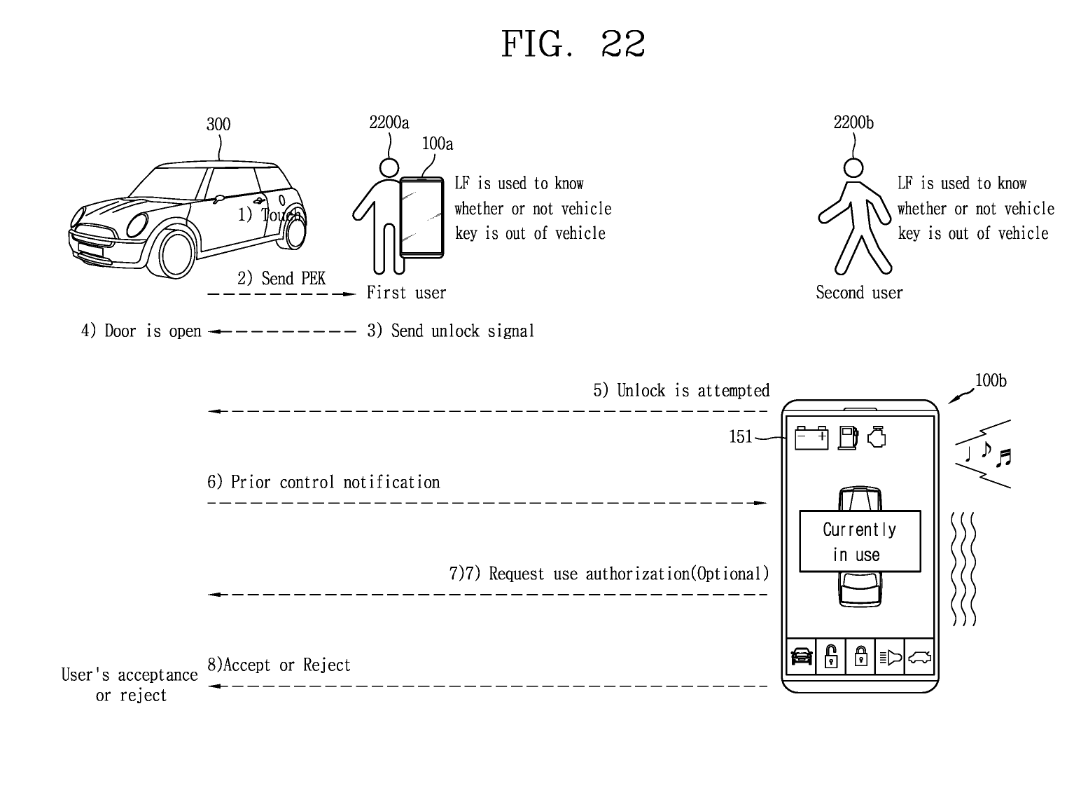

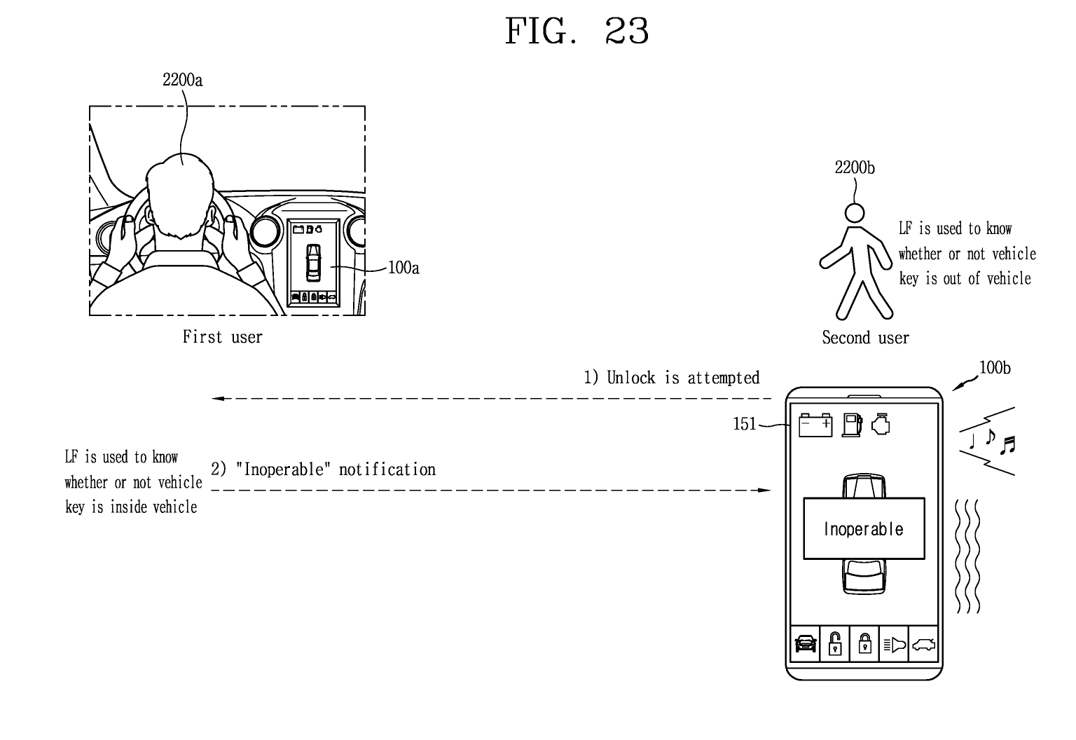

FIGS. 22 and 23 are conceptual views illustrating a control method of a mobile terminal when there are a plurality of mobile terminals (or vehicle key modules) capable of controlling the vehicle 300. Referring to FIG. 22, a mobile terminal capable of controlling the vehicle can include a first mobile terminal 100a and a second mobile terminal 100b.

First, when a first user 2200a having the first mobile terminal 100a performs a preset operation associated with the vehicle in the vehicle 300, the vehicle 300 can send a request associated with the vehicle corresponding to the preset operation (1), 2)). Then, when the request signal is received, the first mobile terminal 100a can transmit a control signal associated with the vehicle corresponding to the request signal to the vehicle in response to the request signal (3)). The vehicle 300 can perform an operation corresponding to a control signal in response to the control signal received from the first mobile terminal 100a (4)).

A preset operation associated with the vehicle can be performed in the vehicle by a second user 2200b holding the second mobile terminal 100b while the vehicle 300 is being controlled by the first mobile terminal 100a (or prior to completing parking of the vehicle 300) (5)). For example, a preset operation performed by the second user can be an operation (e.g., a lock/unlock button press, a trunk button press, etc.) performed in the vehicle or an operation of remotely receiving a preset signal associated with the vehicle by a RKE function on the second mobile terminal 100b.

When a preset operation associated with the vehicle through the second mobile terminal 100b is performed while the vehicle 300 is being controlled by the first mobile terminal 100a (or before the parking of the vehicle 300 is completed), the vehicle can transmit information 2210 indicating that the vehicle is being controlled by the first mobile terminal to the second terminal 100b.

The information 2210 can be displayed on the display unit of the second mobile terminal 100b. Then, the second mobile terminal 100b may selectively transmit a request for authorizing an additional control of the vehicle to the vehicle or the first mobile terminal 100a. The first user 2200a may perform a response to the request through the vehicle or the first mobile terminal 100a. When the response is an approval, the vehicle 300 can be additionally controlled by the control of the second mobile terminal 100b. When the response is a rejection, the vehicle 300 can be controlled by the first mobile terminal 100b, ignoring a control signal transmitted from the second mobile terminal 100b.

FIG. 22 is an example of a state where the first user 2200a carrying the first mobile terminal 100a is inside the vehicle 300. As illustrated in FIG. 22, when a preset operation associated with the vehicle is performed from the second mobile terminal 100b existing outside the vehicle 300 in a state where the first user 2200a carrying the first mobile terminal 100a is inside the vehicle 300, the vehicle 300 can transmit notification information indicating that the vehicle is already being controlled by the first mobile terminal 100a or information indicating that the vehicle is unable to be controlled by the second mobile terminal 100b.

The foregoing description will be analogically applicable to when the mobile terminal 100 includes the vehicle key module 200, when the vehicle key 200-1 (or the vehicle key module 200) and the mobile terminal 100 are physically separated from each other but communicably connected to each other, and when the vehicle key 200-1 (or the vehicle key module 200) is provided with a GPS module or a sensing unit, in the same or similar manner.

The effects of a mobile terminal according to the present disclosure and a control method thereof will be described as follows. The present disclosure can acquire a location of a mobile terminal through a GSP module provided in the mobile terminal, and determine whether or not to transmit a control signal responding to a request signal associated with the vehicle based on the acquired location of the mobile terminal, thereby providing a novel control method capable of preventing a relay attack of the vehicle.

Furthermore, the present disclosure can provide a mobile terminal capable of determining whether or not to transmit a control signal responding to a request signal associated with a vehicle according to a change in location of the mobile terminal, thereby preventing a relay attack of the vehicle in an optimized manner. In addition, the present disclosure can determine whether or not to transmit a control signal responding to a request signal associated with a vehicle based on information acquired from a mobile terminal (e.g., a movement of the mobile terminal, a difference between atmospheric pressures detected by a parked vehicle and the mobile terminal, and a user schedule using the mobile terminal), thereby providing a novel control method capable of effectively preventing a relay attack caused by a weak point of a smart key.

Further scope of applicability of the present disclosure will become apparent from the detailed description given hereinafter. However, it should be understood that the detailed description and specific examples such as preferred embodiments of the invention are given by way of illustration only, since various changes and modifications within the spirit and scope of the invention will become apparent to those skilled in the art from this detailed description.

The foregoing present disclosure may be implemented as codes readable by a computer on a medium written by the program. The computer-readable media includes all types of recording devices in which data readable by a computer system can be stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include the controller 180 of the electronic device. The foregoing embodiments are merely exemplary and are not to be considered as limiting the present disclosure. The scope of the invention should be determined by reasonable interpretation of the appended claims and all changes that come within the equivalent scope of the invention are included in the scope of the invention.

What is claimed is:

1. A mobile terminal, comprising:
a communication unit including a GPS module and configured to receive a request signal for controlling a vehicle; and
a controller configured to:
transmit a control signal for controlling the vehicle through the communication unit in response to the request signal when a location of the vehicle acquired through the GPS module indicates the mobile terminal is within a first distance from the vehicle, and
not transmit the control signal for controlling the vehicle through the communication unit in response to the request signal when the location of the vehicle acquired through the GPS module indicates the mobile terminal is within a second distance from the vehicle greater than the first distance.

2. The mobile terminal of claim 1, wherein the controller is further configured to:
when the request signal is received while the mobile terminal is within the second distance, output notification information indicating that there is an attempted theft of the vehicle.

3. The mobile terminal of claim 2, wherein the controller is further configured to:
when the mobile terminal is within the first distance, determine whether or not to transmit the control signal based on a location trajectory of the mobile terminal acquired through the GPS module.

4. The mobile terminal of claim 3, wherein the controller is further configured to:
control the communication unit to transmit the control signal when the mobile terminal moves closer to the vehicle while being within the first distance, and
not transmit the control signal when the mobile terminal moves away from the vehicle while being within the first distance.

5. The mobile terminal of claim 4, wherein the controller is further configured to:
when the request signal is received while the mobile terminal moves away from the vehicle but is still within the first distance, request a call connection to a preset calling number.

6. The mobile terminal of claim 1, wherein the controller is further configured to:
determine the location of the mobile terminal acquired through the GPS module as a location of the vehicle at a time of transmitting a preset signal associated with the vehicle based on whether the preset signal is transmitted through the communication unit.

7. The mobile terminal of claim 1, wherein the controller is further configured to:
when the location of the mobile terminal is unable to be acquired through the GPS module, determine the location of the vehicle based on movement trajectory information transmitted from the vehicle.

8. The mobile terminal of claim 1, further comprising:
a sensor configured to sense a movement of the mobile terminal,
wherein the controller is further configured to:
when the request signal is received while the mobile terminal is moving in a preset movement, not transmit the control signal for controlling the vehicle.

9. The mobile terminal of claim 8, wherein the controller is further configured to:
when the request signal is received while the movement of the mobile terminal is not sensed through the sensor, not transmit the control signal for controlling the vehicle.

10. The mobile terminal of claim 1, wherein the controller is further configured to:
when the request signal is received while a preset function is being executed on the mobile terminal, not transmit the control signal for controlling the vehicle.

11. The mobile terminal of claim 1, further comprising:
a sensor configured to sense an atmospheric pressure,
wherein the controller is further configured to:
sense a first atmospheric pressure when parking is completed, and sense a second atmospheric pressure through the sensor when the request signal is received, and
not transmit the control signal for controlling the vehicle when a difference between the first atmospheric pressure and the second atmospheric pressure is larger than a predetermined value.

12. The mobile terminal of claim 1, wherein the controller is further configured to:
when the request signal is received through the communication unit while communication is established with an external device, not transmit the control signal for controlling the vehicle.

13. The mobile terminal of claim 1, wherein the controller is further configured to:
determine a time zone that uses the vehicle based on a history in which a signal associated with the vehicle is transmitted and received, and
not transmit the control signal for controlling the vehicle when the request signal is received at a time other than the determined time zone.

14. The mobile terminal of claim 1, wherein the controller is further configured to:
determine a distance between the vehicle and the mobile terminal based on an intensity of a signal transmitted from the vehicle when the location of the mobile terminal is unable to be acquired through the GPS module, and
determine whether or not to transmit the control signal when the request signal is received, based on the determined distance between the vehicle and the mobile terminal.

15. A method of controlling a mobile terminal, the method comprising:
receiving, via a communication unit including a GPS module, a request signal for controlling a vehicle;
transmitting, via a controller, a control signal for controlling the vehicle through the communication unit in response to the request signal when a location of the vehicle acquired through the GPS module indicates the mobile terminal is within a first distance from the vehicle; and
not transmitting, via the controller, the control signal for controlling the vehicle through the communication unit in response to the request signal when the location of the vehicle acquired through the GPS module indicates the mobile terminal is within a second distance from the vehicle greater than the first distance.

16. The method of claim 15, further comprising:
when the request signal is received while the mobile terminal is within the second distance, outputting notification information indicating that there is an attempted theft of the vehicle.

17. The method of claim 16, further comprising:
when the mobile terminal is within the first distance, determining whether or not to transmit the control signal based on a location trajectory of the mobile terminal acquired through the GPS module.

18. The method of claim 17, further comprising:
controlling the communication unit to transmit the control signal when the mobile terminal moves closer to the vehicle while being within the first distance; and
not transmitting the control signal when the mobile terminal moves away from the vehicle while being within the first distance.

19. The method of claim 18, further comprising:
when the request signal is received while the mobile terminal moves away from the vehicle but is still within the first distance, requesting a call connection to a preset calling number.

20. The method of claim 15, further comprising:
determining the location of the mobile terminal acquired through the GPS module as a location of the vehicle at a time of transmitting a preset signal associated with the vehicle based on whether the preset signal is transmitted through the communication unit.
